(19) United States
(12) Patent Application Publication
(10) Pub. No.: US 2022/0050406 A1
(43) Pub. Date: Feb. 17, 2022

(54) METHOD OF REFURBISHING AN INTERMEDIATE TRANSFER MEMBER

(71) Applicant: Hewlett-Packard Development Company, L.P., Spring, TX (US)

(72) Inventors: Dima LIBSTER, Nes Ziona (IL); Dina VOLOSHIN FIROUZ, Nes Ziona (IL); Sergey INOTAEV, Nes Ziona (IL); Gabi HABIBI, Nes Ziona (IL)

(73) Assignee: Hewlett-Packard Development Company, L.P., Spring, TX (US)

(21) Appl. No.: 17/414,611

(22) PCT Filed: Jun. 6, 2019
(86) PCT No.: PCT/US2019/035771

§ 371 Date: Jun. 16, 2021

(51) Int. Cl. G03G 15/16; G03G 15/10; C09D 183/12; C09D 5/00

(52) U.S. Cl. CPC G03G 15/161; G03G 15/10; C08G 77/12; C09D 5/002; G03G 2215/00987; C09D 183/12

(57) ABSTRACT

Described herein is a method of refurbishing an intermediate transfer member (ITM) blanket comprising: cleaning a silicone release layer of the ITM blanket with a cleaning composition; applying a primer composition onto the silicone release layer of the ITM blanket to form a primer layer; applying a silicone release formulation to the primer layer; curing the silicone release formulation to form a silicone release layer; wherein at least one of the cleaning composition and the primer composition comprises a polysiloxane surfactant.

Digital offset printing apparatus typically include an intermediate transfer member (ITM) onto which an image is applied prior to transferring the image to a substrate. Current intermediate transfer members comprise a silicone release layer as the surface layer onto which the ink image is applied. Silicone release layers are formed by condensation curing, thermally assisted addition curing or UV assisted addition curing reactions.

### BRIEF DESCRIPTION OF THE FIGURES

FIG. 1 is a schematic illustration of an example of a digital offset printing apparatus, in this case, a liquid electrostatic printing apparatus.

FIG. 2 is a cross-sectional diagram of an example of an intermediate transfer member (ITM) comprising a base and an ITM blanket.

FIG. 3 is a schematic cross-sectional diagram of an example of an ITM structure.

FIG. 4 is a schematic cross-sectional diagram of another example of an ITM structure.

### DETAILED DESCRIPTION

Before the intermediate transfer member and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an”, and “the” include plural referents unless the context clearly dictates otherwise.

As used herein, “electrophotographic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

Unless otherwise stated, viscosity was measured using an AR-2000 model Rheometer from TAI (Thermal Analysis Instruments)). The rheometer is used as a viscometer, by applying shear forces on the testing sample between two parallel plates. The sample is loaded between parallel plates at a known gap with an oscillatory (sinusoidal) shear profile of from 0.01 to 1,000 s⁻¹ at a temperature of 25° C.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers”, “electrophotographic printing apparatus”, “electrostatic printing apparatus” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the abbreviation “acac” refers to acetylacetonate.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided a method of refurbishing an intermediate transfer member (ITM) blanket. The method of refurbishing an ITM blanket may comprise:
cleaning a silicone release layer of the ITM blanket with a cleaning composition;
applying a primer composition onto the silicone release layer of the ITM blanket to form a primer layer;
applying a silicone release formulation to the primer layer;
curing the silicone release formulation to form a silicone release layer;
wherein at least one of the cleaning composition and the primer composition comprises a polysiloxane surfactant.

In another aspect, there is provided an ITM blanket. The ITM blanket may comprise:
a first silicone release layer;
a primer layer disposed on the first silicone release layer; and
a second silicone release layer disposed on the primer layer.

In a further aspect, there is provided a primer composition. The primer composition may comprise:
a polysiloxane surfactant;
an organosilane; and
at least one of a catalyst or a photoinitiator.

Currently, many ITM blankets are a non-recyclable part of a digital offset printing apparatus that is replaced for numerous reasons, including as a result of deterioration in print quality over time, as part of a troubleshooting process and as a preventative step prior to the detection of any deterioration in print quality. Generally, the first part of an ITM blanket to deteriorate is the silicone release layer, which is therefore the main reason for its replacement.

Since many ITM blankets cannot be recycled, a method of refurbishing the ITM blankets has been sought to reduce the environmental cost of digital offset printing and extend the lifespan of each ITM blanket. The method of refurbishing an intermediate transfer member blanket described herein has been found to adhere a new (i.e., second) silicone release layer to the old (i.e., first) silicone release layer of an ITM blanket.

Method of Refurbishing an Intermediate Transfer Member (ITM) Blanket

In an aspect, there is provided a method of refurbishing an intermediate transfer member (ITM) blanket. The method of refurbishing an ITM blanket may comprise cleaning a silicone release layer of the ITM blanket with a cleaning composition; applying a primer composition onto the silicone release layer of the ITM blanket to form a primer layer; applying a silicone release formulation to the primer layer; curing the silicone release formulation to form a silicone release layer; wherein at least one of the cleaning composition and the primer composition comprises a polysiloxane surfactant.

In some examples, the method of refurbishing an ITM blanket may comprise cleaning a silicone release layer of the ITM blanket with a cleaning composition comprising a polysiloxane surfactant; applying a primer composition onto the silicone release layer of the ITM blanket to form a primer layer; applying a silicone release formulation to the primer layer; and curing the silicone release formulation to form a silicone release layer.

In some examples, the method of refurbishing an ITM blanket may comprise cleaning a silicone release layer of the ITM blanket with a cleaning composition; applying a primer composition comprising a polysiloxane surfactant onto the silicone release layer of the ITM blanket to form a primer layer; applying a silicone release formulation to the primer layer; and curing the silicone release formulation to form a silicone release layer.

In some examples, the method of refurbishing an ITM blanket may comprise cleaning a silicone release layer of the ITM blanket with a cleaning composition; applying a primer composition onto the silicone release layer of the ITM blanket to form a primer layer; applying a silicone release formulation to the primer layer; curing the silicone release formulation to form a silicone release layer; wherein both the cleaning composition and the primer composition comprise a polysiloxane surfactant. In some examples, the cleaning composition and the primer composition may comprise the same polysiloxane surfactant or different polysiloxane surfactants.

In some examples, the method of refurbishing an ITM blanket may comprise cleaning a silicone release layer of the ITM blanket with a cleaning composition comprising a polysiloxane surfactant; applying a primer composition comprising a polysiloxane surfactant onto the silicone release layer of the ITM blanket to form a primer layer; applying a silicone release formulation to the primer layer; and curing the silicone release formulation to form a silicone release layer.

In some examples, the method of refurbishing an ITM blanket is a method of refurbishing an ITM blanket having a silicone release layer thereon.

In some examples, the ITM blanket being refurbished may be any ITM blanket comprising a silicone release layer. In some examples, the ITM blanket being refurbished may be an ITM blanket for a digital offset printing apparatus. In some examples, the ITM blanket being refurbished may have been used in a digital offset printing apparatus. In some examples, the ITM blanket being refurbished may have been used in a digital offset printing apparatus until print quality has noticeably deteriorated.

In some examples, cleaning the silicone release layer of the ITM blanket with a cleaning composition comprises applying the cleaning composition to the silicone release layer of the ITM blanket. In some examples, the cleaning composition may be applied to the silicone release layer of the ITM blanket manually or by machine. In some examples, the cleaning composition may be applied to the silicone release layer of the ITM blanket by a cleaning roller.

In some examples, after cleaning the silicone release layer of the ITM blanket with a cleaning composition, the silicone release layer of the ITM blanket is dried. In some examples, drying of the silicone release layer may comprise heating the ITM blanket.

In some examples, cleaning the silicone release layer of the ITM blanket with a cleaning composition removes adhered particles, for example, adhered particles of ink, from the surface of the silicone release layer. In some examples, cleaning the silicone release layer of the ITM blanket with a cleaning composition increases the surface free energy of the silicone release layer. In some examples, the surface free energy of the silicone release layer after cleaning with the cleaning composition is at least about 40 mN/m, for example, at least about 45 mN/m, at least about 50 mN/m, at least about 55 mN/m, at least about 60 mN/m, at least about 61 mN/m, at least about 62 mN/m, at least about 63 mN/m, at least about 64 mN/m, at least about 65 mN/m, at least about 66 mN/m, at least about 67 mN/m, at least about 68 mN/m, at least about 69 mN/m. In some examples, the surface free energy of the silicone release layer after cleaning with the cleaning composition is about 100 mN/m or less, for example, about 95 mN/m or less, about 90 mN/m or less, about 85 mN/m or less, about 80 mN/m or less, about 79 mN/m or less, about 78 mN/m or less, about 77 mN/m or less, about 76 mN/m or less, about 75 mN/m or less, about 74 mN/m or less, about 73 mN/m or less, about 72 mN/m or less, about 71 mN/m or less, about 70 mN/m or less. In some examples, the surface free energy of the silicone release layer after cleaning with the cleaning composition is from about 40 mN/m to about 100 mN/m, for example, about 45 mN/m to about 95 mN/m, about 50 mN/m to about 90 mN/m, about 55 mN/m to about 85 mN/m, about 60 mN/m to about 80 mN/m, about 61 mN/m to about 79 mN/m, about 62 mN/m to about 78 mN/m, about 63 mN/m to about 77 mN/m, about 64 mN/m to about 76 mN/m, about 65 mN/m to about 75 mN/m, about 66 mN/m to about 74 mN/m, about 67 mN/m to about 73 mN/m, about 68 mN/m to about 72 mN/m, about 69 mN/m to about 71 mN/m, about 50 mN/m to about 70 mN/m. The surface free energy may be calculated by using the Owens-Wendt-Rabel-Kaelble algorithm using the mean contact angles for at least water and diiodomethane, for example, by using software available from Kruss company.

In some examples, the primer composition is applied onto the silicone release layer of the ITM blanket using gravure coating, calendering, rod coating, flexo coating, screen coating, spray coating, roll coating, reverse roll coating, gap coating, slot die coating, immersion coating, curtain coating, air knife coating, flood coating, lithography, or combinations thereof. In some examples, the primer composition is applied onto the silicone release layer of the ITM blanket using gravure coating.

In some examples, the primer composition is applied onto the silicone release layer of the ITM blanket at a gravure volume of about 1 cm³/m² or more, for example, about 2 cm³/m² or more, about 3 cm³/m² or more, about 4 cm³/m² or more, about 5 cm³/m² or more, about 6 cm³/m² or more, about 7 cm³/m² or more, or about 8 cm³/m² or more. In some examples, the primer composition is applied onto the silicone release layer of the ITM blanket at a gravure volume of about 15 cm³/m² or less, for example, about 14 cm³/m² or less, about 13 cm³/m² or less, about 12 cm³/m² or less, about 11 cm³/m² or less, about 10 cm³/m² or less, about 9 cm³/m² or less, or about 8 cm³/m² or less. In some examples, the primer composition is applied onto the silicone release layer of the ITM blanket at a gravure volume of about 1 cm³/m² to about 15 cm³/m², about 2 cm³/m² to about 14 cm³/m², about 3 cm³/m² to about 13 cm³/m², about 4 cm³/m² to about 12 cm³/m², about 5 cm³/m² to about 11 cm³/m², about 6 cm³/m² to about 10 cm³/m², about 7 cm³/m² to about 9 cm³/m², or about 8 cm³/m² to about 15 cm³/m².

In some examples, applying the primer composition onto the silicone release layer of the ITM blanket to form a primer layer comprises applying the primer composition onto the silicone release layer of the ITM blanket and curing the primer composition to form a primer layer.

In some examples, applying the primer composition onto the silicone release layer of the ITM blanket to form a primer layer comprises applying a first primer composition onto the silicone release layer of the ITM blanket and applying a second primer composition onto the first primer composition. In some examples, applying the primer composition onto the silicone release layer of the ITM blanket to form a primer layer comprises applying a first primer composition onto the silicone release layer of the ITM blanket; curing the first primer composition to form a first primer layer; and applying a second primer composition to the first primer layer. In some examples, the second primer composition is cured before the silicone release formulation is applied to the second primer layer. In some examples, the second primer composition is not cured before the silicone release formulation is applied to the second primer layer. In some examples, the silicone release formulation is applied to the second primer layer immediately after the second primer composition is applied to the first primer layer.

In some examples, the first primer composition may facilitate bonding or joining of the silicone release layer (which may be termed the second silicone release layer) to the silicone release layer of the ITM blanket (which may be termed the first silicone release layer). In some examples, the second primer composition may facilitate bonding of the silicone release formulation (which may be termed the second silicone release layer) to the silicone release layer of the ITM blanket (which may be termed the first silicone release layer) via the first primer composition.

In some examples, the first primer composition is applied onto the silicone release layer of the ITM blanket using gravure coating, calendering, rod coating, flexo coating, screen coating, spray coating, roll coating, reverse roll coating, gap coating, slot die coating, immersion coating, curtain coating, air knife coating, flood coating, lithography, or combinations thereof. In some examples, the first primer composition is applied onto the silicone release layer of the ITM blanket using gravure coating.

In some examples, the first primer composition is applied onto the silicone release layer of the ITM blanket at a gravure volume of about 1 cm³/m² or more, for example, about 2 cm³/m² or more, about 3 cm³/m² or more. In some examples, the primer composition is applied onto the silicone release layer of the ITM blanket at a gravure volume of about 5 cm³/m² or less, about 4 cm³/m² or less, or about 3 cm³/m² or less. In some examples, the primer composition is applied onto the silicone release layer of the ITM blanket at a gravure volume of about 1 cm³/m² to about 5 cm³/m², about 2 cm³/m² to about 4 cm³/m², about 3 cm³/m² to about 5 cm³/m², about 1 cm³/m² to about 3 cm³/m².

In some examples, the first primer composition is a thermally curable first primer composition or a radiation curable first primer composition. In some examples, the first primer composition is a radiation curable first primer composition. In some examples, the first primer composition may comprise a cross-linking compound capable of cross-linking to the silicone release layer of the ITM blanket on which it is disposed. In some examples, the first primer composition is cured by thermal curing or by irradiation, for example, by UV light. In some examples, the first primer composition is cured by irradiation, for example, by UV light.

In some examples, curing of the first primer composition may comprise irradiating the first primer composition to provide a first primer layer, i.e., a layer of cured first primer composition. In some examples, irradiating the first primer composition comprises irradiating with light having a wavelength that corresponds to the optimal wavelength for the photoinitiator. In some examples, the step of irradiating comprises irradiating the coating of the first primer composition using UV irradiation. The duration of the irradiation will depend on the power rating of the radiation source being used and the actual power supplied. In some examples, irradiating the first primer composition comprises irradiating in order to fully cure the first primer composition. In some examples, irradiating the first primer composition comprises irradiating in order to at least partially cure the first primer composition. In some examples, the radiation-cured first primer composition comprises a polymerisation product of an epoxysilane, a vinyl silane, an allyl silane, an acrylate functional silane, and a methacrylate functional silane, and mixtures thereof.

In some examples, the second primer composition is applied onto the first primer composition after curing of the first primer composition. In some examples, the second primer composition is applied onto the first primer composition, for example, the first primer layer, using gravure coating, calendering, rod coating, flexo coating, screen coating, spray coating, roll coating, reverse roll coating, gap coating, slot die coating, immersion coating, curtain coating, air knife coating, flood coating, lithography, or combinations thereof. In some examples, the second primer composition is applied onto the first primer composition, for example, the first primer layer, using gravure coating.

In some examples, the second primer composition is applied onto the first primer composition at a gravure volume of about 3 cm³/m² or more, for example, about 4 cm³/m² or more, about 5 cm³/m² or more. In some examples, the primer composition is applied onto the silicone release layer of the ITM blanket at a gravure volume of about 10 cm³/m² or less, for example, about 9 cm³/m² or less, about 8 cm³/m² or less, about 7 cm³/m² or less, about 6 cm³/m² or less, about 5 cm³/m² or less. In some examples, the second primer composition is applied onto the first primer composition at a gravure volume of about 3 cm³/m² to about 10 cm³/m², about 4 cm³/m² to about 9 cm³/m², about 5 cm³/m² to about 8 cm³/m², about 3 cm³/m² to about 7 cm³/m², about 4 cm³/m² to about 6 cm³/m².

In some examples, the method may comprise applying a silicone release formulation to the primer layer. In some examples, the method comprises applying the silicone release formulation to the second primer layer. In some examples, the method may comprise applying a silicone release formulation to an uncured primer layer, for example, an uncured second primer layer.

In some examples, the silicone release formulation is applied to the primer layer by extrusion, calendering, lamination, gravure coating, rod coating, flexo coating, screen coating, spray coating, gravure coating, roll coating, reverse roll coating, gap coating, slot die coating, immersion coating, curtain coating, air knife coating, flood coating, lithography, or combinations thereof. Using these methods, the silicone release formulation can be processed in a straightforward manner with or without the use of solvents.

In some examples, the silicone release formulation is applied to the primer layer at a gravure volume of 1 cm³/m² or more, in some examples, 2 cm³/m² or more, in some examples, 3.5 cm³/m² or more, in some examples, 3.6 cm³/m² or more, in some examples, 3.7 cm³/m² or more, in some examples, 3.8 cm³/m² or more, in some examples, 3.9 cm³/m² or more, in some examples, 4 cm³/m² or more, in some examples, 4.1 cm³/m² or more, in some examples, 4.2 cm³/m². In some examples, the silicone release formulation is applied to the primer layer at a gravure volume of 20 cm³/m² or less, in some examples, 15 cm³/m² or less, in some examples, 10 cm³/m² or less, in some examples, 5 cm³/m² or less, in some examples, 4.9 cm³/m² or less, in some examples, 4.8 cm³/m² or less, in some examples, 4.7 cm³/m² or less, in some examples, 4.6 cm³/m² or less, in some examples, 4.5 cm³/m² or less, in some examples, 4.4 cm³/m² or less, in some examples, 4.3 cm³/m², in some examples, 4.2 cm³/m². In some examples, the silicone release formulation is applied to the primer layer at a gravure volume of 1 cm³/m² to 20 cm³/m², in some examples, 2 cm³/m² to 15 cm³/m², in some examples, 3 cm³/m² to 10 cm³/m², in some examples, 3.5 cm³/m² to 5 cm³/m², in some examples, 4 cm³/m² to 4.5 cm³/m².

In some examples, the silicone release formulation is a thermally curable silicone release formulation or a radiation curable silicone release formulation. In some examples, the silicone release formulation is a thermally curable silicone release formulation. In some examples, the silicone release formulation is a radiation curable silicone release formulation. In some examples, the silicone release formulation is cured by thermal curing or by irradiation, for example, by UV light. In some examples, the silicone release formulation is cured by irradiation, for example, by UV light.

In some examples, thermal curing comprises heating, for example, in an oven. In some examples, thermal curing comprises heating to a temperature of at least about 75° C., for example, at least about 80° C., at least about 85° C., at least about 90° C., at least about 95° C., at least about 100° C., at least about 105° C., or at least about 110° C. In some examples, thermal curing comprises heating to a temperature of about 150° C. or less, for example, about 145° C., about 140° C., about 135° C., about 130° C., about 125° C., about 120° C., about 115° C., or about 110° C. In some examples, thermal curing comprises heating to a temperature of from about 75° C. to about 150° C., about 80° C. to about 145° C., about 85° C. to about 140° C., about 90° C. to about 135° C., about 95° C. to about 130° C., about 100° C. to about 125° C., about 105° C. to about 120° C., or about 110° C. to about 115° C. In some examples, thermal curing comprises heating for 1 h or less, for example, 45 min or less or 30 min or less.

In some examples, curing the silicone release formulation by irradiation may comprise irradiating the silicone release formulation for 1 second or more, in some examples, 2 seconds or more, in some examples, 3 seconds or more, in some examples, 4 seconds or more, in some examples, 5 seconds or more, in some examples, 6 seconds or more, in some examples, 7 seconds or more, in some examples, 8 seconds or more, in some examples, 9 seconds or more, in some examples, 10 seconds or more, in some examples, 15 seconds or more, in some examples, 20 seconds or more. In some examples, the curing the silicone release formulation by irradiation may comprise irradiating the silicone release formulation for 20 seconds or less, in some examples, 10 seconds or less, in some examples, 9 seconds or less, in some examples 8 seconds or less, in some examples, 7 seconds or less, in some examples, 6 seconds or less, in some examples, 5 seconds or less, in some examples, 5 seconds or less, in some examples, 4 seconds or less, in some examples, 3 seconds or less, in some examples, 2 seconds or less, in some examples, 1 second or less. In some examples, curing the silicone release formulation by irradiation may comprise irradiating the silicone release formulation for 1 second to 20 seconds, in some examples, 2 seconds to 10 seconds, in some examples, 3 seconds to 9 seconds, in some examples, 4 seconds to 8 seconds, in some examples, 5 seconds to 7 seconds, in some examples, 5 seconds to 6 seconds.

In some examples, the silicone release formulation passes the irradiation source, for example, at a speed of 1 m/min or more, in some examples, 2 m/min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the silicone release formulation passes the irradiation source at a speed of 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the silicone release formulation passes the irradiation source at a speed of 1 m/min to 10 m/min, in some examples, 2 m/min to 9 m/min, in some examples, 2 m/min to 8 m/min, in some examples, 3 m/min to 7 m/min, in some examples, 4 m/min to 6 m/min, in some examples, 5 m/min to 6 m/min.

In some examples, the irradiation source is a UV irradiation source, for example, an LED UV lamp, a Hg UV lamp, a Xenon arc lamp, or a microwave UV lamp. In some examples, the Xenon arc lamp is selected from a pure xenon arc lamp or a xenon-mercury arc lamp. In some examples, the irradiation source is an LED UV lamp.

In some examples, curing the silicone release formulation may comprise simultaneously curing the primer composition and the silicone release formulation. In some examples, curing the silicone release formulation may comprise simultaneously curing the second primer composition and the silicone release formulation.

In some examples, the silicone release formulation is applied onto the primer layer with a layer thickness of 1 μm or more, for example, 1.5 μm or more, for example, 2 μm or more, for example, 3 μm or more, for example, 4 μm or more. In some examples, the UV silicone release formulation is applied onto the primer layer with a layer thickness of 8 μm or less, for example, 7 μm or less, for example, 6 μm or less, for example, 5 μm or less, for example, 4 μm or less, for example, 3 μm or less, for example, 2 μm or less, for example, 1.5 μm or less, for example, about 1 μm. For example, the silicone release formulation is applied onto primer layer with a layer thickness of from 1 μm to 8 μm, for example, of from 1.5 μm to 7 μm, for example, of from 2 μm to 6 μm, for example, of from 2 μm to 4 μm.

In some examples, the method of refurbishing an intermediate transfer member (ITM) blanket may comprise cleaning a silicone release layer of the ITM blanket with a cleaning composition; applying a first primer composition onto the silicone release layer of the ITM blanket to form a first primer layer; applying a second primer composition onto the first primer layer to form a second primer layer; applying a silicone release formulation to the second primer layer; curing the silicone release formulation to form a silicone release layer; wherein at least one of the cleaning composition, the first primer composition and the second primer composition comprises a polysiloxane surfactant.

In some examples, the method of refurbishing an intermediate transfer member (ITM) blanket may comprise cleaning a silicone release layer of the ITM blanket with a cleaning composition; applying a first primer composition onto the silicone release layer of the ITM blanket; curing the first primer composition to form a first primer layer; applying a second primer composition to the first primer layer to form a second primer layer; applying a silicone release formulation to the second primer layer; curing the silicone release formulation to form a silicone release layer; wherein at least one of the cleaning composition, the first primer composition and the second primer composition comprises a polysiloxane surfactant.

In some examples, the method of refurbishing an intermediate transfer member (ITM) blanket may comprise cleaning a silicone release layer of the ITM blanket with a cleaning composition; applying a first primer composition onto the silicone release layer of the ITM blanket; curing the first primer composition to form a first primer layer; applying a second primer composition to the first primer layer to form a second primer layer; applying a silicone release formulation to the second primer layer; simultaneously curing the second primer composition and the silicone release formulation to form a silicone release layer; wherein at least one of the cleaning composition, the first primer composition and the second primer composition comprises a polysiloxane surfactant.

Polysiloxane Surfactant

In some examples, the polysiloxane surfactant is selected from disiloxane surfactants, trisiloxane surfactants and tetrasiloxane surfactants. In some examples, the polysiloxane surfactant is a trisiloxane surfactant.

In some examples, the polysiloxane surfactant, for example, the trisiloxane surfactant, has a hydrophilic-lipophilic balance (HLB) is in the range of about 9 to about 13, for example, about 10 to about 12. The HLB may be determined by using Griffin's method, wherein the HLB=20*Mh/M, in which Mh is the molecular mass of the hydrophilic portion of the molecule and M is the molecular mass of the whole molecule.

In some examples, the trisiloxane surfactant may be a polyalkylene oxide modified trisiloxane, for example, a polyalkylene oxide modified polyalkyltrisiloxane. In some examples, the trisiloxane surfactant may be a polyalkylene oxide modified heptamethyltrisiloxane.

In some examples, the trisiloxane surfactant is a trisiloxane surfactant according to formula 1

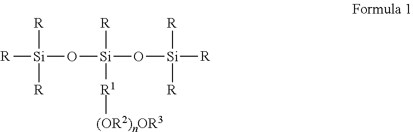

In some examples, each R, R¹ and R² are each independently selected from alkyl groups. In some examples, each R, R¹ and R² are each independently selected from C1 to C10 alkyl groups. In some examples, each R, R¹ and R² are each independently selected from C1 to C6 alkyl groups.

In some examples, R² may comprise a mixture of alkyl groups.

In some examples, each R group is independently selected from C1 to C6 alkyl groups. In some examples, each R group is independently selected from methyl, ethyl and propyl. In some examples, each R group may be the same or different. In some examples, each R group is a methyl group.

In some examples, R¹ is selected from C1 to C10 alkyl groups. In some examples, R¹ is selected from C1 to C6 alkyl groups. In some examples, R¹ is selected from C1, C2, C3, C4, C5 and C6 alkyl groups. In some examples, R¹ is selected from methyl, ethyl, propyl, isopropyl, butyl, isobutyl, tert-butyl, pentyl and hexyl groups. In some examples, R¹ is selected from methyl, ethyl, propyl and isopropyl groups. In some examples, R¹ is (CH₂)₃.

In some examples, R² is selected from C1 to C6 alkyl groups and mixtures thereof. In some examples, R² is selected from C1, C2, C3, C4, C5 and C6 alkyl groups and mixtures thereof. In some examples, R² is selected from methyl, ethyl, propyl and isopropyl and mixtures thereof. In some examples, R² is selected from ethyl, isopropyl and mixtures thereof.

In some examples, n is an integer of at least 1. In some examples, n is an integer of 1 to 12. In some examples, n is an integer of 1 to 11, for example, 2 to 10, 3 to 9, 4 to 8, 5 to 7, or 6 to 12.

In some examples, R² is selected from ethyl, isopropyl and mixtures thereof and n is an integer of at least 1, for example, 1 to 12. In some examples, R² is ethyl and n is an integer of at least 1, for example 1 to 12. In some examples, R² is isopropyl and n is an integer of at least 1, for example, 1 to 12. In some examples, R² is a mixture of ethyl and isopropyl and n is an integer of at least 1, for example, 1 to 12. In some examples, R² is a mixture of ethyl and isopropyl and n is an integer of at least 1, for example, 1 to 12, wherein the ratio of ethyl to isopropyl may be 3:2.

In some examples, R³ is selected from hydrogen and alkyl groups, for example, C1 to C10 alkyl groups. In some examples, R³ is selected from hydrogen and C1 to C6 alkyl groups, for example, C1 to C4 alkyl groups. In some examples, R³ is selected from hydrogen, methyl, ethyl, propyl, butyl, pentyl and hexyl. In some examples, R³ is selected from hydrogen, methyl and ethyl. In some examples, R³ is selected from hydrogen and methyl. In some examples, R³ is hydrogen. In some examples, R³ is methyl.

In some examples, the trisiloxane surfactant is a trisiloxane surfactant according to formula 1

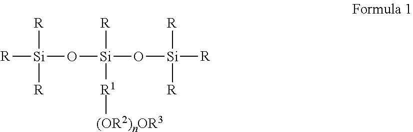

wherein

each R is independently selected from C1 to C6 alkyl groups;

R¹ is selected from C1 to C6 alkyl groups;

each R² is independently selected from C1 to C6 alkyl groups;

R³ is selected from hydrogen and C1 to C6 alkyl groups; and

n is an integer of at least 1.

In some examples, the trisiloxane surfactant is a trisiloxane surfactant according to formula 1

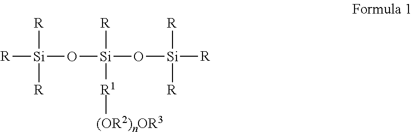

wherein

R, R¹ and R² are each independently selected from C1 to C6 alkyl groups;

R³ is selected from hydrogen and C1 to C6 alkyl groups; and

n is an integer of at least 1.

In some examples, the trisiloxane surfactant is

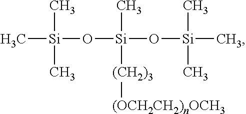

wherein n is an integer of at least 1, for example, an integer in the range of 1 to 12.

Cleaning Composition

In some examples, the cleaning composition comprises a solvent. In some examples, the cleaning composition comprises a solvent and a polysiloxane surfactant. In some examples, the polysiloxane surfactant may be any polysiloxane surfactant described above.

In some examples, the cleaning composition comprises polysiloxane surfactant in an amount of about 10 wt. % or less, for example, about 9 wt. % or less, about 8 wt. % or less, about 7 wt. % or less, about 6 wt. % or less, about 5 wt. % or less, about 4 wt. % or less, about 3 wt. % or less, or about 2 wt. % or less. In some examples, the cleaning composition comprises polysiloxane surfactant in an amount of about 0.1 wt. % or more, for example, about 0.5 wt. % or more, about 0.6 wt. % or more, about 0.7 wt. % or more, about 0.8 wt. % or more, about 0.9 wt. % or more, about 1 wt. % or more, about 1.1 wt. % or more, about 1.2 wt. % or more, about 1.3 wt. % or more, about 1.4 wt. % or more, about 1.5 wt. % or more, about 1.6 wt. % or more, about 1.7 wt. % or more, about 1.8 wt. % or more, about 1.9 wt. % or more, or about 2 wt. % or more. In some examples, the cleaning composition comprises polysiloxane surfactant in an amount of about 0.1 wt. % to about 10 wt. %, for example, about 0.5 wt. % to about 10 wt. %, about 0.6 wt. % to about 9 wt. %, about 0.7 wt. % to about 8 wt. %, about 0.8 wt. % to about 7 wt. %, about 0.9 wt. % to about 6 wt. %, about 1 wt. % to about 5 wt. %, about 1.1 wt. % to about 4 wt. %, about 1.2 wt. % to about 3 wt. %, about 1.3 wt. % to about 2 wt. %, about 1.4 wt. % to about 10 wt. %, about 1.5 wt. % to about 9 wt. %, about 1.6 wt. % to about 8 wt. %, about 1.7 wt. % to about 7 wt. %, about 1.8 wt. % to about 6 wt. %, about 1.9 wt. % to about 5 wt. %, or about 2 wt. % to about 4 wt. %. In some examples, the solvent constitutes the remaining weight of the cleaning composition.

In some examples, the solvent may be any solvent capable of dissolving or dispersing the polysiloxane surfactant. In some examples, the solvent may be any solvent capable of dissolving the polysiloxane surfactant. In some examples, the solvent may be an alcohol (for example, a C1 to C10 alcohol), ethyl acetate, butyl acetate, acetonitrile, or dimethyl sulfoxide (DMSO). In some examples, the solvent may be an alcohol, for example, a C1 to C10 alcohol. In some examples, the solvent may be selected from methanol, ethanol, propanol (e.g., propan-1-ol or propan-2-ol, i.e., isopropanol), butanol, pentanol, hexanol, heptanol, and octanol. In some examples, the solvent may be selected from ethanol, propanol (e.g., propan-1-ol or propan-2-ol) and butanol. In some examples, the solvent may be propan-1-ol or propan-2-ol. In some examples, the solvent is propan-2-ol.

Primer Composition

In some examples, the primer composition facilitates adhesion of the silicone release formulation to the silicone release layer of the ITM blanket. In some examples, the primer composition is any primer composition capable of facilitating adhesion of the silicone release formulation to the silicone release layer of the ITM blanket. The primer composition may or may not comprise a polysiloxane surfactant. In some examples, the primer composition may comprise a polysiloxane surfactant. The polysiloxane surfactant may be any polysiloxane surfactant described above.

In some examples, the primer composition is a curable primer composition.

In some examples, the primer composition may comprise an organosilane and at least one of a catalyst or a photoinitiator. In some examples, the primer composition comprises a polysiloxane surfactant; an organosilane; and at least one of a catalyst or a photoinitiator.

In some examples, the organosilane may be selected from an epoxysilane, a vinyl silane, an allyl silane, an acryloxysilane, an unsaturated silane, or mixtures thereof. In some examples, the epoxysilane may be (3-glycidoxypropyl)trimethoxysilane (available from, for example, ABCR GmbH & Co. KG, Im Schlehert 10 D-76187, Karlsruhe, Germany, product code SIG5840). In some examples, the vinyl silane may be vinyltriethoxysilane (VTEO, available from, for example, Evonik, Kirschenallee, Darmstadt, 64293, Germany) or vinyltrimethoxysilane (V3M, available from, for example, ABCR). In some examples, the acryloxysilane may be a methacyloxysilane, for example, 3-methacryloxypropyltrimethoxysilane (e.g., Dynasylan® MEMO™ available from Degussa, AG of Piscataway, N.J.).

In some examples, the catalyst may comprise titanium, platinum, or rhodium. In some examples, the catalyst comprising titanium may be an organic titanate or a titanium chelate. In some examples, the catalyst comprising platinum may be Karstedt's catalyst, that is, platinum divinyl tetramethyl disiloxane.

In some examples, the primer composition comprises a first primer composition and a second primer composition. In some examples, the primer composition comprises a first primer composition and a second primer composition, wherein, in the method of refurbishing the ITM blanket, the first primer composition is applied onto the silicone release layer of the ITM blanket and then the second primer composition is applied onto the first primer composition. In some examples, the primer composition comprises a first primer composition and a second primer composition, wherein, in the method of refurbishing the ITM blanket, the first primer composition is applied onto the silicone release layer of the ITM blanket and cured, for example, by irradiation, and then the second primer composition is applied onto the cured first primer composition.

In some examples, the first primer composition may be curable by a condensation reaction. In some examples, the first primer composition may comprise a catalyst for catalysing the condensation reaction. In some examples, the second primer composition may be curable by an addition cure reaction. In some examples, the second primer composition may comprise a catalyst for catalysing an addition cure reaction. In some examples, the first primer composition may be curable by a condensation reaction and the second primer may be curable by an addition reaction.

In some examples, the first primer composition may be curable by a photopolymerisation reaction. In some examples, the first primer composition may be curable by a photopolymerisation reaction and the second primer composition may be curable by a condensation reaction and/or by an addition reaction.

First Primer Composition

In some examples, the first primer composition comprises at least one of a catalyst and a photoinitiator. In some examples, the first primer composition comprises a photoinitiator.

In some examples, the first primer composition comprises an organosilane and at least one of a catalyst or a photoinitiator. In some examples, the first primer composition comprises a polysiloxane surfactant; an organosilane and at least one of a catalyst or a photoinitiator.

In some examples, the first primer composition may comprise an organosilane and a photoinitiator. In some examples, the first primer composition may comprise an organosilane, a photoinitiator, and a polysiloxane surfactant. In some examples, the organosilane in the first primer composition may be selected from epoxysilanes, acryloxysilanes and mixtures thereof. In some examples, the organosilane in the first primer composition may be selected from (3-glycidoxypropyl)trimethoxysilane, 3-methacryloxypropyltrimethoxysilane and mixtures thereof. In some examples, the photoinitiator may be 2-hydroxy-2-methylpropiophenone. In some examples, the first primer composition is curable by a condensation reaction.

In some examples, the first primer composition may be a radiation curable primer composition. In some examples, the radiation curable primer composition is cured by UV light.

In some examples, the first primer composition comprises a photoinitiator to facilitate cross-linking of the organosilane to itself and with the silicone release layer of the ITM blanket on which it is disposed. In some examples, the photoinitiator includes, but is not limited to, α-hydroxyketones, α-aminoketones, benzaldimethyl-ketal, and mixtures thereof. In one example, the photoinitiator can comprise 2-hydroxy 2-methyl 1-phenyl 1-propanone, for example, Darocur® 1173™, available from BASF, CAS number 7473-98-5. Other suitable photoinitiators include, but are not limited to, Irgacure® 500™ (a 50/50 blend of 1-hydroxy-cyclohexyl phenyl ketone and benzophenone), Irgacure®651™ (an α,α-dimethoxy α-phenyl acetophenone), Irgacure® 907™ (2-methyl-1-[4-(methylthio)phenyl]-2-(4-morpholinyl)-1-propanone) from BASF. Additionally, any other suitable photoinitiators may be used. Generally, the first primer composition may comprise a photoinitiator in an amount of about 1 wt. % to about 20 wt. % of the total first primer composition. In one example, the first primer composition may comprise a photoinitiator in an amount of about 1 wt. % to about 5 wt. % of the total first primer composition.

Second Primer Composition

In some examples, the second primer composition comprises an organosilane and at least one of a catalyst and a photoinitiator. In some examples, the second primer composition comprises a polysiloxane surfactant, an organosilane and at least one of a catalyst and a photoinitiator.

In some examples, the second primer composition may comprise an organosilane and a catalyst. In some examples, the second primer composition may comprise an organosilane, a catalyst and a polysiloxane surfactant.

In some examples, the second primer composition is thermally curable. In some examples, the second primer composition comprises a reactive monomer with addition polymerisable groups and condensation polymerisable groups.

In some examples, the organosilane in the second primer composition may be selected from epoxysilanes, aminosilanes, alkylsilanes, vinylsilanes, allylsilanes, unsaturated silanes, non-functional dipodal silanes (e.g., bis triethoxysilane octane) and their condensed forms constituted by oligomers of the monomeric form of the silane. In some examples, the second primer composition comprises a hydrolysable portion. In some examples, the hydrolysable portion of the silane comprises an alkoxy group (e.g., alkoxysilane with an alkoxy group selected form the group consisting of methoxy, ethoxy, propoxy, isopropoxy, methoxyethoxy, and the like).

In some examples, the organosilane in the second primer composition comprises an epoxyalkyl alkoxysilane (e.g., glycidoxypropyl trimethoxysilane-silane Dynasilan GLYMO (Degussa)). In some example, the hydrolysable group may also be an oxime group (e.g., methylethylketoxime group) or an acetoxy group. Another illustrative example of an organosilane useful in the second primer is a hydrolysable vinyl silane, for example, vinyltriethoxysilane (VTEO, available from Evonik, Kirschenallee, Darmstadt, 64293, Germany) or vinyltrimethoxysilane, a hydrolysable allyl silane or a hydrolysable unsaturated silane. In some examples, the second primer may comprise (3-glycidoxypropyl)trimethoxysilane and/or vinyltrimethoxysilane.

In some examples, the organosilane in the second primer composition may be selected from epoxysilanes, vinylsilanes and mixtures thereof. In some examples, the organosilane may be selected from (3-glycidoxypropyl)trimethoxysilane, vinyltrimethoxysilane and mixtures thereof. In some examples, the catalyst may be selected from titanium diisopropoxide bis(acetylacetonate), platinum divinyltetramethyldisiloxane and mixtures thereof. In some examples, the second primer composition is also curable by a condensation reaction. In some examples, the second primer composition may be curable by an addition reaction.

In some examples, the second primer composition comprises at least one of a catalyst and a photoinitiator. In some examples, the second primer composition comprises a catalyst. In some examples, the second primer composition comprises at least one catalyst, optionally two catalysts. In some examples, the second primer composition comprises a catalyst for addition cure reactions and a catalyst for condensation reactions. In some examples, the second primer composition comprises a first catalyst and a second catalyst, which are different from each other. In some examples, the catalyst in the second primer composition comprises a first catalyst and a second catalyst. In some examples, the first and second catalysts catalyse different types of polymerisation reaction. In some examples, the first catalyst catalyses condensation polymerisation reactions. In some examples, the second catalyst catalyses addition polymerisation reactions. In some examples, the second primer composition comprises first and second catalysts, with the first catalyst catalysing the curing of the second primer composition itself and the second catalyst catalysing the curing of the silicone release formulation. In some examples, the first catalyst also catalyses the cross-linking of the second primer composition to the first primer composition, which may or may not have been cured before the second primer composition is applied onto the first primer composition. In some examples, the second catalyst also catalyses the cross-linking of the second primer composition to the silicone release formulation.

In some examples, the first catalyst of the second primer composition comprises a titanate or a tin catalyst, or, alternatively, comprises any suitable compound that is capable of catalysing a condensation curing reaction of the organosilane of the second primer composition. In certain embodiments, the first catalyst comprises an organic titanate catalyst such as acetylacetonate titanate chelate, available as, for example, Tyzor® AA-75 from E.I. du Pont de Nemours and Company of Wilmington, Del.)

In some examples, the first catalyst comprises about 1 wt. % to 20 wt. % of the total primer layer. In some examples, the first catalyst comprises about 1 wt. % to 5 wt. % of the total primer layer. Without being bound by theory, it is believed that acetylacetonate titanate chelate (e.g., Tyzor® AA-75) initiates a condensation reaction between the components of the first and second primer compositions, inducing adhesion between the first and second primer compositions.

In some examples, the second catalyst comprises platinum, or any other catalyst capable of catalysing an addition curing reaction of the second primer composition. In some examples, the second catalyst comprises platinum or rhodium. In some examples, the second catalyst comprises a Karstedt catalyst with for example 9 wt. % or 10 wt. % platinum in solution (available from Johnson Matthey, 5th Floor, 25 Farringdon Street, London EC4A 4AB, United Kingdom) or SIP6831.2 catalyst (available from Gelest, 11 East Steel Road, Morrisville, Pa. 19067, USA).

In some examples, the first primer composition comprises a photoinitiator and the second primer composition comprises a catalyst. In some examples, the first primer composition comprises a photoinitiator and the second primer composition comprises a first catalyst and a second catalyst.

In some examples, the catalyst for a silane condensation reaction may be an organic titanate such as Tyzor® AA75 (available from Dorf-Ketal Chemicals India Private Limited Dorf Ketal Tower, D'Monte Street, Orlem, Malad (W), Mumbai-400064, Maharashtra, INDIA). In some examples, the catalyst may be a Karstedt catalyst with, for example, 9% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, Pa. 19067, USA).

Silicone Release Formulation

In some examples, the silicone release formulation may be any silicone release formulation capable of being cured to form a silicone release layer.

In some examples, the silicone release formulation may comprise a polyalkylsiloxane containing at least two vinyl groups; a polyalkylsiloxane cross-linker containing at least two Si—H bonds; and a catalyst or photoinitiator. In some examples, the silicone release formulation may comprise a polyalkylsiloxane containing at least two vinyl groups; a polyalkylsiloxane cross-linker containing at least two Si—H bonds; a catalyst or photoinitiator; and conductive particles. In some examples, the silicone release formulation may comprise a polyalkylsiloxane containing at least two vinyl groups; a polyalkylsiloxane cross-linker containing at least two Si—H bonds; a catalyst or photoinitiator; and a thermal inhibitor. In some examples, the silicone release formulation may comprise a polyalkylsiloxane containing at least two vinyl groups; a polyalkylsiloxane cross-linker containing at least two Si—H bonds; a catalyst or photoinitiator; conductive particles and a thermal inhibitor.

In some examples, the silicone release formulation is thermally curable or radiation curable. In some examples, the catalyst or photoinitiator is selected to allow thermal curing or radiation curing.

Polyalkylsiloxane Containing at Least Two Vinyl Groups

In some examples, the silicone release formulation comprises a polyalkylsiloxane containing at least two vinyl groups. In some examples, the polyalkylsiloxane containing at least two vinyl groups is selected from a linear polyalkylsiloxane containing at least two vinyl groups, a branched polyalkylsiloxane containing at least two vinyl groups, a cyclic polyalkylsiloxane containing at least two vinyl groups and mixtures thereof. In some examples, the polyalkylsiloxane containing at least two vinyl groups is a linear polyalkylsiloxane containing at least two vinyl groups.

In some examples, the polyalkylsiloxane containing at least two vinyl groups comprises a vinyl-terminated polyalkylsiloxane having the following formula:

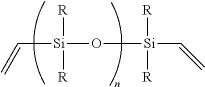

wherein each R is independently selected from C1 to C6 alkyl; and n is 1 or more.

In some examples, each R is independently selected from C1, C2, C3, C4, C5 and C6 alkyl. In some examples, each R is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R is independently selected from methyl, ethyl, n-propyl, isopropyl, n-butyl, sec-butyl, isobutyl, and tert-butyl. In some examples, each R is independently selected from methyl, ethyl, n-propyl, and isopropyl. In some examples, each R is the same. In some examples, each R is methyl.

In some examples, n is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, n is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less, in some examples, 2 or less. In some examples, n is 1 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the vinyl-terminated polyalkylsiloxane has a viscosity at 25° C. of 250 mPa·s or more, in some examples, 300 mPa·s or more, in some examples, 350 mPa·s or more, in some examples, 400 mPa·s or more, in some examples, 450 mPa·s or more, in some examples, 500 mPa·s or more, in some examples, 550 mPa·s or more, in some examples 600 mPa·s or more, in some examples, 650 mPa·s or more, in some examples, 700 mPa·s or more, in some examples, about 750 mPa·s. In some examples, the vinyl-terminated polyalkylsiloxane has a viscosity at 25° C. or 750 mPa·s or less, in some examples, 700 mPa·s or less, in some examples, 650 mPa·s or less, in some examples, 600 mPa·s or less, in some examples, 550 mPa·s or less, in some examples, 500 mPa·s or less, in some examples, 450 mPa·s or less, in some examples, 400 mPa·s or less, in some examples, 350 mPa·s or less, in some examples, 300 mPa·s or less, in some examples, about 250 mPa·s. In some examples, the vinyl-terminated polyalkylsiloxane has a viscosity at 25° C. of 250 mPa·s to 750 mPa·s, in some examples, 300 mPa·s to 700 mPa·s, in some examples, 350 mPa·s to 650 mPa·s, in some examples, 400 mPa·s to 600 mPa·s, in some examples, 450 mPa·s to 550 mPa·s, in some examples, 450 mPa·s to 500 mPa·s.

In some examples, the vinyl-terminated polyalkylsiloxane may have a vinyl content of 0.05 mmol/g or more, in some examples, 0.06 mmol/g or more, in some examples, 0.07 mmol/g or more, in some examples, 0.08 mmol/g or more, in some examples, 0.09 mmol/g or more, in some examples, 0.1 mmol/g or more, in some examples, 0.11 mmol/g or more, in some examples, 0.12 mmol/g or more, in some examples, 0.13 mmol/g or more, in some examples, 0.14 mmol/g or more, in some examples, 0.15 mmol/g or more, in some examples, 0.16 mmol/g or more, in some examples, 0.17 mmol/g or more, in some examples, 0.18 mmol/g or more, in some examples, 0.19 mmol/g or more, in some examples, 0.2 mmol/g or more, in some examples, 0.3 mmol/g or more, in some examples, 0.4 mmol/g or more, in some examples, 0.5 mmol/g or more, in some examples, about 0.6 mmol/g. In some examples, the vinyl-terminated polyalkylsiloxane may have a vinyl content of 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.19 mmol/g or less, in some examples, 0.18 mmol/g or less, in some examples, 0.17 mmol/g or less, in some examples, 0.16 mmol/g or less, in some examples, 0.15 mmol/g or less, in some examples, 0.14 mmol/g or less, in some examples, 0.13 mmol/g or less, in some examples, 0.12 mmol/g or less, in some examples, 0.11 mmol/g or less, in some examples, 0.1 mmol/g or less, in some examples, 0.09 mmol/g or less, in some examples, 0.08 mmol/g or less, in some examples, 0.07 mmol/g or less, in some examples, 0.06 mmol/g or less, in some examples, about 0.05 mmol/g. In some examples, the vinyl-terminated polyalkylsiloxane may have a vinyl content of 0.05 mmol/g to 0.6 mmol/g, in some examples, 0.06 mmol/g to 0.5 mmol/g, in some examples, 0.07 mmol/g to 0.4 mmol/g, in some examples, 0.08 mmol/g to 0.3 mmol/g, in some examples, 0.09 mmol/g to 0.2 mmol/g, in some examples, 0.1 mmol/g to 0.19 mmol/g, in some examples, 0.11 mmol/g to 0.18 mmol/g, in some examples, 0.12 mmol/g to 0.17 mmol/g, in some examples, 0.13 mmol/g to 0.16 mmol/g, in some examples, 0.14 mmol/g to 0.15 mmol/g.

In some examples, the polyalkylsiloxane containing at least two vinyl groups comprises a pendent vinyl polyalkylsiloxane having the following formula:

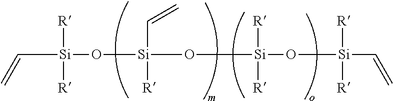

wherein each R′ is independently selected from C1 to C6 alkyl; and m is 1 or more; and o is 0 or more.

In some examples, each R′ is independently selected from C1, C2, C3, C4, C5 and C6 alkyl. In some examples, each R′ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′ is independently selected from methyl, ethyl, n-propyl, isopropyl, n-butyl, sec-butyl, isobutyl, and tert-butyl. In some examples, each R′ is independently selected from methyl, ethyl, n-propyl, and isopropyl. In some examples, each R′ is the same. In some examples, each R′ is methyl.

In some examples, m is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, m is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples 5 or less. In some examples, m is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, o is 0 or more, in some examples, 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, o is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less. In some examples, o is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500

In some examples, the pendent vinyl polyalkylsiloxane has a viscosity at 25° C. of 2500 mPa·s or more, in some examples, 2550 mPa·s or more, in some examples, 2600 mPa·s or more, in some examples, 2650 mPa·s or more, in some examples, 2700 mPa·s or more, in some examples, 2750 mPa·s or more, in some examples, 2800 mPa·s or more, in some examples 2900 mPa·s or more, in some examples, 3000 mPa·s or more, in some examples, 3050 mPa·s or more, in some examples, 3100 mPa·s or more, in some examples, 3150 mPa·s or more, in some examples, 3200 mPa·s or more, in some examples, 3250 mPa·s or more, in some examples, 3300 mPa·s or more, in some examples, 3350 mPa·s or more, in some examples, 3400 mPa·s or more, in some examples, 3450 mPa·s or more, in some examples, about 3500 mPa·s. In some examples, the pendent vinyl polyalkylsiloxane has a viscosity at 25° C. or 3500 mPa·s or less, in some examples, 3450 mPa·s or less, in some examples, 3400 mPa·s or less, in some examples, 3350 mPa·s or less, in some examples, 3300 mPa·s or less, in some examples, 3250 mPa·s or less, in some examples, 3200 mPa·s or less, in some examples, 3150 mPa·s or less, in some examples, 3100 mPa·s or less, in some examples, 3050 mPa·s or less, in some examples, 3000 mPa·s or less, in some examples, 2950 mPa·s or less, in some examples, 2900 mPa·s or less, in some examples, 2850 mPa·s or less, in some examples, 2800 mPa·s or less, in some examples, 2750 mPa·s or less, in some examples, 2700 mPa·s or less, in some examples, 2650 mPa·s or less, in some examples, about 2500 mPa·s. In some examples, the pendent vinyl polyalkylsiloxane has a viscosity at 25° C. of 2500 mPa·s to 3500 mPa·s, in some examples, 2550 mPa·s to 3450 mPa·s, in some examples, 2600 mPa·s to 3400 mPa·s, in some examples, 2650 mPa·s to 3350 mPa·s, in some examples, 2700 mPa·s to 3300 mPa·s, in some examples, 2750 mPa·s to 3250 mPa·s, in some examples, 2800 mPa·s to 3200 mPa·s, in some examples, 2850 mPa·s to 3150 mPa·s, in some examples, 2900 mPa·s to 3100 mPa·s, in some examples, 2950 mPa·s to 3050 mPa·s, in some examples, 3000 mPa·s to 3050 mPa·s.

In some examples, the pendent vinyl polyalkylsiloxane may have a vinyl content of 0.1 mmol/g or more, 0.2 mmol/g or more, in some examples, 0.3 mmol/g or more, in some examples, 0.4 mmol/g or more, in some examples, 0.5 mmol/g or more, in some examples, 0.6 mmol/g or more, in some examples, 0.7 mmol/g or more, in some examples, 0.8 mmol/g or more, in some examples, 0.9 mmol/g or more, in some examples, 1 mmol/g or more, in some examples, 2 mmol/g or more. In some examples, the vinyl-terminated polyalkylsiloxane may have a vinyl content of 2 mmol/g or less, in some examples, 1 mmol/g or less, in some examples, 0.9 mmol/g or less, in some examples, 0.8 mmol/g or less, in some examples, 0.7 mmol/g or less, in some examples, 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.1 mmol/g or less. In some examples, the vinyl-terminated polyalkylsiloxane may have a vinyl content of 0.1 mmol/g to 2 mmol/g, in some examples, 0.2 mmol/g to 1 mmol/g, in some examples, 0.3 mmol/g to 0.9 mmol/g, in some examples, 0.4 mmol/g to 0.8 mmol/g, in some examples, 0.5 mmol/g to 0.7 mmol/g, in some examples, 0.3 mmol/g to 0.6 mmol/g.

In some examples, the polyalkylsiloxane containing at least two vinyl groups comprises a mixture of a vinyl-terminated polyalkylsiloxane having the following formula:

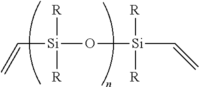

wherein each R is independently selected from C1 to C6 alkyl; and n is 1 or more; and a pendent vinyl polyalkylsiloxane having the following formula:

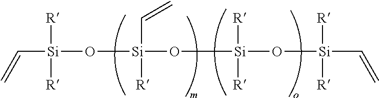

wherein each R′ is independently selected from C1 to C6 alkyl; m is 1 or more; and o is 0 or more. In some examples, the each R, each R′, n, m and o may be as defined above.

In some examples, the polyalkylsiloxane containing at least two vinyl groups comprises a vinyl-terminated polyalkylsiloxane and a pendent vinyl polyalkylsiloxane. In some examples, the polyalkylsiloxane containing at least two vinyl groups comprises a mixture of vinyl-terminated polyalkylsiloxane and pendent vinyl polyalkylsiloxane in a ratio of from 1:10 to 10:1. In some examples, the polyalkylsiloxane containing at least two vinyl groups comprises a mixture of vinyl-terminated polyalkylsiloxane and pendent vinyl polyalkylsiloxane in a ratio of from 1:9 to 9:1 mixture, in some examples, from 1:8 to 8:1, in some examples, from 1:7 to 7:1, in some examples, from 1:6 to 6:1, in some examples, from 1:5 to 5:1, in some examples, from 1:4 to 4:1, in some examples, from 1:3 to 3:1, in some examples, from 1:2 to 2:1, in some examples, from 1:1 to 4:1.

Suitable examples of the polyalkylsiloxane containing at least two vinyl groups include Polymer VS 50, Polymer VS 100, Polymer VS 200, Polymer VS 500, Polymer VS 1000, Polymer VS 200, Polymer RV 100, Polymer RV 200, Polymer RV 500, available from Evonik Industries. Other suitable examples include DMS-V00, DMS-V03, DMS-V05, DMS-V21, DMS-V22, DMS-V25, DMS-V31, DMS-V33, DMS-V34, DMS-V35, DMS-V41, DMS-V42, DMS-V43, DMS-V46, DMS-V51, and DMS-V52 from Gelest Inc., Stroofstrasse 27, Geb.2901, 65933 Frankfurt am Main, Germany).

Polyalkylsiloxane Cross-Linker Containing at Least Two Si—H Bonds

In some examples, the silicone release formulation comprises a polyalkylsiloxane cross-linker containing at least two Si—H bonds. In some examples, the polyalkylsiloxane cross-linker is selected from a linear polyalkylsiloxane cross-linker, a branched polyalkylsiloxane cross-linker and a cyclic polyalkylsiloxane cross-linker. In some examples, the polyalkylsiloxane cross-linker containing at least two Si—H bonds is a linear polyalkylsiloxane cross-linker.

In some examples, the polyalkylsiloxane containing at least two Si—H bonds comprises a polyalkylsiloxane cross-linker having the following formula:

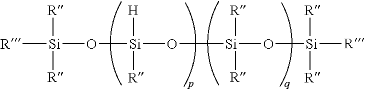

wherein each R″ is independently selected from C1 to C6 alkyl; each R′″ is independently selected from H and C1 to C6 alkyl; p is 2 or more; and q is 0 or more.

In some examples, each R″ is independently selected from C1, C2, C3, C4, C5 and C6 alkyl. In some examples, each R″ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R″ is independently selected from methyl, ethyl, n-propyl, isopropyl, n-butyl, sec-butyl, isobutyl, and tert-butyl. In some examples, each R″ is independently selected from methyl, ethyl, n-propyl, and isopropyl. In some examples, each R″ is the same. In some examples, each R″ is methyl.

In some examples, each R′″ is independently selected from H, C1, C2, C3, C4, C5 and C6 alkyl. In some examples, each R′″ is independently selected from H, methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′″ is independently selected from H, methyl, ethyl, n-propyl, isopropyl, n-butyl, sec-butyl, isobutyl, and tert-butyl. In some examples, each R′″ is independently selected from H, methyl, ethyl, n-propyl, and isopropyl. In some examples, each R′″ is the same. In some examples, each R′″ is H or methyl.

In some examples, p is 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, p is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less. In some examples, p is 2 to 50, in some examples, 3 to 10, in some examples, 4 to 9, in some examples, 5 to 8, in some examples, 6 to 7.

In some examples, q is 0 or more, in some examples, 1 or more, in some examples, 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, q is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less, in some examples, 1 or less. In some examples, q is 0 to 50, in some examples, 1 to 10, in some examples, 2 to 9, in some examples, 3 to 8, in some examples, 4 to 7, in some examples, 5 to 6.

In some examples, the polyalkylsiloxane cross-linker may be a random copolymer, a block copolymer, an alternating copolymer or a periodic copolymer. In some examples, the polyalkylsiloxane cross-linker may be a random copolymer.

In some examples, the polyalkylsiloxane cross-linker has a viscosity at 25° C. of 5 mPa·s or more, in some examples, 10 mPa·s or more, in some examples, 15 mPa·s or more, in some examples, 20 mPa·s or more, in some examples, 25 mPa·s or more, in some examples, 30 mPa·s or more, in some examples, 35 mPa·s or more, in some examples 40 mPa·s or more, in some examples, 45 mPa·s or more, in some examples, 50 mPa·s or more, in some examples, 55 mPa·s or more, in some examples, 60 mPa·s or more, in some examples, 65 mPa·s or more, in some examples, 70 mPa·s or more, in some examples, 75 or more, in some examples, about 80 mPa·s. In some examples, the polyalkylsiloxane cross-linker has a viscosity at 25° C. or 80 mPa·s or less, in some examples, 75 mPa·s or less, in some examples, 70 mPa·s or less, in some examples, 65 mPa·s or less, in some examples, 60 mPa·s or less, in some examples, 55 mPa·s or less, in some examples, 50 mPa·s or less, in some examples, 45 mPa·s or less, in some examples, 40 mPa·s or less, in some examples, 35 mPa·s or less, in some examples, 30 mPa·s or less, in some examples, 25 mPa·s or less, in some examples, 20 mPa·s or less, in some examples, 15 mPa·s or less, in some examples, about 10 mPa·s. In some examples, the polyalkylsiloxane cross-linker has a viscosity at 25° C. of 10 mPa·s to 80 mPa·s, in some examples, 15 mPa·s to 75 mPa·s, in some examples, 20 mPa·s to 70 mPa·s, in some examples, 25 mPa·s to 65 mPa·s, in some examples, 30 mPa·s to 60 mPa·s, in some examples, 35 mPa·s to 55 mPa·s, in some examples, 40 mPa·s to 50 mPa·s, in some examples, 40 mPa·s to 45 mPa·s.

In some examples, the polyalkylsiloxane cross-linker may have an Si—H content of 1 mmol/g or more, in some examples, 2 mmol/g or more, in some examples, 3 mmol/g or more, in some examples, 3.5 mmol/g or more, in some examples, 4 mmol/g or more, in some examples, 4.1 mmol/g or more, in some examples, 4.2 mmol/g or more, in some examples, 4.3 mmol/g or more, in some examples, 4.5 mmol/g or more, in some examples, 5 mmol/g or more, in some examples, 6 mmol/g or more, in some examples, 7 mmol/g or more, in some examples, about 8 mmol/g. In some examples, the polyalkylsiloxane cross-linker may have an Si—H content of 8 mmol/g or less, in some examples, 7 mmol/g or less, in some examples, 6 mmol/g or less, in some examples, 5 mmol/g or less, in some examples, 4.5 mmol/g or less, in some examples, 4.4 mmol/g or less, in some examples, 4.3 mmol/g or less, in some examples, 4.2 mmol/g or less, in some examples, 4.1 mmol/g or less, in some examples, 4 mmol/g or less, in some examples, 3.5 mmol/g or less, in some examples, 3 mmol/g or less, in some examples, 2 mmol/g or less, in some examples, about 1 mmol/g. In some examples, the polyalkylsiloxane cross-linker may have an Si—H content of 1 mmol/g to 8 mmol/g, in some examples, 2 mmol/g to 7 mmol/g, in some examples, 3 mmol/g to 6 mmol/g, in some examples, 3.5 mmol/g mmol/g to 5 mmol/g, in some examples, 4 mmol/g to 4.5 mmol/g, in some examples, 4.1 mmol/g to 4.4 mmol/g, in some examples, 4.2 mmol/g to 4.3 mmol/g.

Suitable examples of the polyalkylsiloxane cross-linker include Cross-linker 200, Cross-linker 210, Cross-linker 100, Cross-linker 101, Cross-linker 120, Cross-linker 125 or Cross-linker 190, available from Evonik Industries. Other suitable crosslinkers include HMS-031, HMS-071, HMS-082, HMS-013, and HMS-064 from Gelest Inc., Stroofstrasse 27, Geb.2901, 65933 Frankfurt am Main, Germany).

In some examples, the silicone release formulation comprises a ratio of polyalkylsiloxane containing cross-linker to polyalkylsiloxane containing at least two vinyl groups such that the mole ratio of hydride to vinyl is from 4:1 to 1:4. In some examples, the silicone release formulation comprises a ratio of polyalkylsiloxane containing cross-linker to polyalkylsiloxane containing at least two vinyl groups such that the mole ratio of hydride to vinyl is from 3:1 to 1:3, in some examples, 2.5:1 to 1:2.5, in some examples, 2:1 to 1:2, in some examples, 2:1 to 1:1, in some examples, about 2:1, for example, 2.1:1.

In some examples, the silicone release formulation comprises a weight ratio of polyalkylsiloxane containing cross-linker to polyalkylsiloxane containing at least two vinyl groups of from 1:20 to 1:1, in some examples, 1:19 to 1:2, in some examples, 1:18 to 1:3, in some examples, 1:17 to 1:4, in some examples, 1:16 to 1:5, in some examples, 1:15 to 1:6, in some examples, 1:14 to 1:7, in some examples, 1:13 to 1:8, in some examples, 1:12 to 1:9, in some examples, 1:11 to 1:10. In some examples, the silicone release formulation comprises a weight ratio of polyalkylsiloxane containing cross-linker to polyalkylsiloxane containing at least two vinyl groups of from 1:10.

Catalyst or Photoinitiator

In some examples, the catalyst or photoinitiator may be an addition curing catalyst, a condensation curing catalyst, or a photoinitiator.

In some examples, the addition curing catalyst may be a catalyst comprising platinum. In some examples, the photoinitiator is a [Pt(acac)₂] or a UV-A photoinitiator.

In some examples, the catalyst or photoinitiator may comprise be a platinum containing catalyst, a rhodium containing catalyst, a titanium containing catalyst,

In some examples, the catalyst or photoinitiator may be selected from [Pt(acac)₂], platinum divinyl tetramethyl disiloxane (Karstedt's catalyst), a UV-A photoinitiator such as QPI-3100™ (available from Polymer G, Israel), which is designated for curing under UV-A with a wavelength of 395 nm (UV-LED at 395 nm).

In some examples, the silicone release formulation may comprise (by total weight of the formulation) 2000 ppm or less of a catalyst or a photoinitiator, in some examples, 1500 ppm or less, in some examples, 1000 ppm or less, in some examples, 500 ppm or less, in some examples, 250 ppm or less, in some examples, 200 ppm or less, in some examples, 150 ppm or less, in some examples, 100 ppm or less, in some examples, 95 ppm or less, in some examples, 90 ppm or less, in some examples, 85 ppm or less, in some examples, 80 ppm or less, in some examples, 75 ppm or less, in some examples, 70 ppm or less, in some examples, 65 ppm or less, in some examples, 60 ppm or less, in some examples, 55 ppm or less, in some examples, 50 ppm or less of a catalyst or a photoinitiator. In some examples, the silicone release formulation may comprise (by total weight of the formulation) 1 ppm or more of a catalyst or photoinitiator, in some examples, 5 ppm or more, in some examples, 10 ppm or more, in some examples, 15 ppm or more, in some examples, 20 ppm or more, in some examples, 25 ppm or more of a catalyst or photoinitiator. In some examples, the silicone release formulation may comprise (by total weight of the formulation) 1 ppm to 2000 ppm of a catalyst or photoinitiator, in some examples, 1 ppm to 1000 ppm, in some examples, 5 ppm to 500 ppm, in some examples, 10 ppm to 250 ppm, in some examples, 10 ppm to 100 ppm, in some examples, 20 ppm to 75 ppm, in some examples, 25 ppm to 50 ppm of a catalyst or photoinitiator.

Thermal Inhibitor

In some examples, the silicone release formulation comprises a thermal inhibitor. In some examples, the thermal inhibitor comprises an acetylenic alcohol or an alkanol. In some examples, the thermal inhibitor inhibits thermal curing of the polyalkylsiloxane containing at least two vinyl groups and the polyalkylsiloxane cross-linker. In some examples, although no catalyst for thermal activation of the cross-linking reaction is present in the silicone release formulation, thermal curing may be initiated during high shear mixing of the silicone release formulation due to degradation of the catalyst or photoinitiator, for example, [Pt(acac)₂] or Karstedt's catalyst, and therefore the presence of a thermal inhibitor suppresses this reaction, suppressing the associated increase in viscosity of the silicone release formulation.

In some examples, the silicone release formulation comprises 0.01 wt. % to 10 wt. % thermal inhibitor, in some examples, 0.05 wt. % to 9 wt. %, in some examples, 0.1 wt. % to 8 wt. %, in some examples, 0.1 wt. % to 7 wt. %, in some examples, 0.5 wt. % to 6 wt. %, in some examples, 1 wt. % to 5 wt. %, in some examples, 1.5 wt. % to 4 wt. %, in some examples, 2 wt. % to 3.5 wt. %, in some examples, 2.5 wt. % to 3 wt. % thermal inhibitor. In some examples, no thermal inhibitor is used.

Suitable examples of the thermal inhibitor include Inhibitor 600, Inhibitor 500 and Inhibitor 400 from Evonik. Other suitable thermal inhibitors include 1,3-divinyltetramethyldisiloxane (C₈H₁₈OSi₂) and 1,3,5,7-tetravinyl-1,3,5,7-tetramethylcyclotetrasiloxane (C₁₂H₂₄O₄Si₄), both from Gelest Inc.

Conductive Particles

The silicone release formulation may comprise conductive particles. In some examples, the conductive particles may be electrically conductive particles. In some examples, the conductive particles may be carbon black particles.

In some examples, the silicone release formulation may comprise 0.01 wt. % to 10 wt. % conductive particles, in some examples, 0.05 wt. % to 9 wt. %, in some examples, 0.1 wt. % to 8 wt. %, in some examples, 0.25 wt. % to 7 wt. %, in some examples, 0.5 wt. % to 6 wt. %, in some examples, 0.75 wt. % to 5 wt. %, in some examples, 0.8 wt. % to 4 wt. %, in some examples, 0.85 wt. % to 3 wt. %, in some examples, 0.9 wt. % to 2.5 wt. %, in some examples, 0.95 wt. % to 2 wt. %, in some examples, 1 wt. % to 1.5 wt. % conductive particles.

Suitable examples of the conductive particles include carbon black particles from AkzoNobel under the name Ketjenblack® EC600JD.

Digital Offset Printing Apparatus

In some examples, the ITM blanket being refurbished may be an ITM blanket for a digital offset printing apparatus.

In some examples, the digital offset printing apparatus may be any digital offset printing apparatus comprising an intermediate transfer member. In some examples, the digital offset printing apparatus may be a transfer inkjet printing apparatus or an electrostatic printing apparatus, for example, a dry toner electrostatic printing apparatus or a liquid electrostatic printing apparatus. In some examples, a transfer inkjet printing apparatus is an inkjet printing apparatus in which the ink is jetted onto an intermediate transfer member to form an image on the intermediate transfer member before the image is transferred from the intermediate transfer member to a substrate. In some examples, the digital offset printing apparatus is a liquid electrostatic (LEP) printing apparatus.

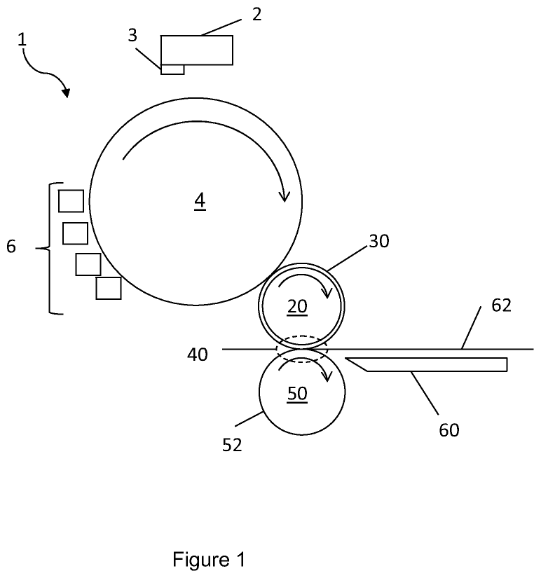

FIG. 1 shows a schematic illustration of an example of an LEP printing apparatus 1 and the use of an intermediate transfer member therein. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of photo-imaging cylinder 4, before being transferred to a silicone release layer 30 of the intermediate transfer member (ITM) 20 which is in the form of a roller (first transfer), and then from the silicone release layer 30 of the ITM 20 to a print substrate 62 (second transfer).

According to an illustrative example, the initial image is formed on rotating photo-imaging cylinder 4 by photo charging unit 2. Firstly, photo charging unit 2 deposits a uniform static charge on photo-imaging cylinder 4 and then a laser imaging portion 3 of photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to photo-imaging cylinder 4 by binary ink developer (BID) units 6. The BID units 6 present a uniform film of liquid electrophotographic ink to photo-imaging cylinder 4. The liquid electrophotographic ink contains electrically charged pigment particles which, by virtue of an appropriate potential on the electrostatic image areas, are attracted to the latent electrostatic image on photo-imaging cylinder 4. The liquid electrophotographic ink does not adhere to the uncharged, non-image areas and forms a developed toner image on the surface of the latent electrostatic image. Photo-imaging cylinder 4 then has a single colour ink image on its surface.

The developed toner image is then transferred from photo-imaging cylinder 4 to the silicone release layer 30 of ITM 20 by electrical forces. The image is then dried and fused on silicone release layer 30 of ITM 20 before being transferred from release layer 30 of ITM 20 to a print substrate disposed on impression cylinder 50. The process may then be repeated for each of the coloured ink layers to be included in the final image.

The image is transferred from photo-imaging cylinder 4 to ITM 20 by virtue of an appropriate potential applied between photo-imaging cylinder 4 and ITM 20, such that the charged ink is attracted to ITM 20.

Between the first and second transfers, the solid content of the developed toner image is increased and the ink is fused on to ITM 20. For example, the solid content of the developed toner image deposited on silicone release layer 30 after the first transfer is typically around 20%, by the second transfer the solid content of the developed toner image is typically around 80-90%. This drying and fusing is typically achieved by using elevated temperatures and airflow-assisted drying. In some examples, ITM 20 is heatable.

The print substrate 62 is fed into the printing apparatus by print substrate feed tray 60 and is disposed on impression cylinder 50. As print substrate 62 contacts ITM 20, the single colour image is transferred to print substrate 62.

To form a single colour image (such as a black and white image), one pass of print substrate 62 through impression cylinder 50 and ITM 20 completes the image. For a multiple colour image, print substrate 62 may be retained on the impression cylinder 50 and make multiple contacts with ITM 20 as it passes through nip 40. At each contact an additional colour plane may be placed on print substrate 62.

Intermediate Transfer Member

The intermediate transfer member may be termed an ITM herein for brevity. In some examples, the ITM may comprise a base and an ITM blanket.

In some examples, the ITM blanket may comprise a first silicone release layer; a primer layer disposed on the first silicone release layer; and a second silicone release layer disposed on the primer layer.

In some examples, the first silicone release layer is the silicone release layer of an ITM blanket that was in need of refurbishment. In some examples, the second silicone release layer is formed by the method of refurbishing an ITM blanket.

In some examples, the ITM blanket comprises a supportive portion on which the first silicone release layer is disposed. The supportive portion may be termed an intermediate transfer member body herein.

The ITM may have a base, for example, a metal base. The base may have a cylindrical shape.

The ITM may have a cylindrical shape; as such, the ITM may be suitable for use as a roller, for example, a roller in a digital offset printing apparatus.

The supportive portion of the ITM blanket may comprise a layered structure disposed on the base of the ITM. The supportive portion may comprise a layer comprising a thermoplastic polyurethane.

The layered structure may comprise a compliant substrate layer, for example, a rubber layer or a layer comprising a thermoplastic polyurethane, on which the first silicone release layer may be disposed. The compliant substrate layer may comprise a thermoplastic polyurethane layer or a rubber layer. The rubber layer may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The ITM blanket may comprise a primer layer to facilitate bonding or joining of the first silicone release layer to the compliant layer. The primer layer may form part of the supportive portion of the ITM, in some examples, the primer layer is disposed on the compliant substrate layer.

In some examples, the primer layer on which the first silicone release layer is disposed may be a primer layer as described above. In some examples, the primer layer on which the first silicone release layer is disposed may comprise a first primer layer and a second primer layer as described above. The primer layer may be applied to the compliant substrate layer of the supportive portion of the ITM blanket before the first silicone release formulation is applied to the supportive portion. The primer layer may comprise an organosilane and a catalyst, for example, a catalyst comprising titanium.

In some examples, the ITM blanket may comprise an adhesive layer for joining the compliant substrate layer to the base. The adhesive layer may be a fabric layer, for example, a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer, a compliance layer and/or a conductive layer. A “conductive layer” may be a layer comprising electrically conductive particles. In some examples, any one or more of the plurality of compliant layers may comprise a thermoplastic polyurethane.

In some examples, the compressible layer is disposed on the base of an ITM. The compressible layer may be joined to the base of the ITM by the adhesive layer. A conductive layer may be disposed on the compressible layer. The compliance layer may then be disposed on the conductive layer, if present, or disposed on the compressible layer if no conductive layer is present. If the compressible layer and/or the compliance layer are partially conducting there may be no requirement for an additional conductive layer.

The compressible layer may have a large degree of compressibility. In some examples, the compressible layer may be 600 μm thick.

The compressible layer may comprise a thermoplastic polyurethane layer, a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In some examples, the compressible layer may comprise carbon black to increase its thermal conductivity.

In some examples, the compressible layer includes small voids, which may be as a result of microspheres or blowing agents used in the formation of the compressible layer. In some examples, the small voids comprise about 40% to about 60% by volume of the compressible layer.

The compliance layer may comprise a thermoplastic polyurethane, a soft elastomeric material having a Shore A hardness value of less than about 65, or a Shore A hardness value of less than about 55 and greater than about 35, or a Shore A hardness value of between about 42 and about 45. In some examples, the compliance layer comprises a polyurethane, a thermoplastic polyurethane or an acrylic. Shore A hardness is determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM). In some examples, the compliance layer comprises a thermoplastic polyurethane.

In an example the compressible layer and the compliance layer are formed from the same material.

The conductive layer may comprise a rubber, for example, an acrylic rubber (ACM), a nitrile rubber (NBR), a hydrogenated nitrile rubber (HNBR), or an EPDM rubber (an ethylene propylene diene terpolymer), and one or more conductive materials, including but not limited to carbon black or metallic particles. In some examples, the conductive layer may comprise a thermoplastic polyurethane and one or more conductive materials, including but not limited to carbon black or metallic particles.

In some examples, the compressible layer and/or the compliance layer may be made to be partially conducting with the addition of conducting particles, for example, conductive carbon black, metal particles or metal fibres. In some examples, where the compressible layer and/or the compliance layer are partially conducting there may be no requirement for an additional conductive layer.

In some examples, the intermediate transfer member blanket comprises, in the following order:
a. a fabric layer;
b. a compressible layer, which may have voids therein;
c. a layer comprising electrically conductive particles;
d. an optional compliant layer;
e. a first silicone release layer;
f. a primer layer disposed on the first silicone release layer; and
g. a second silicone release layer

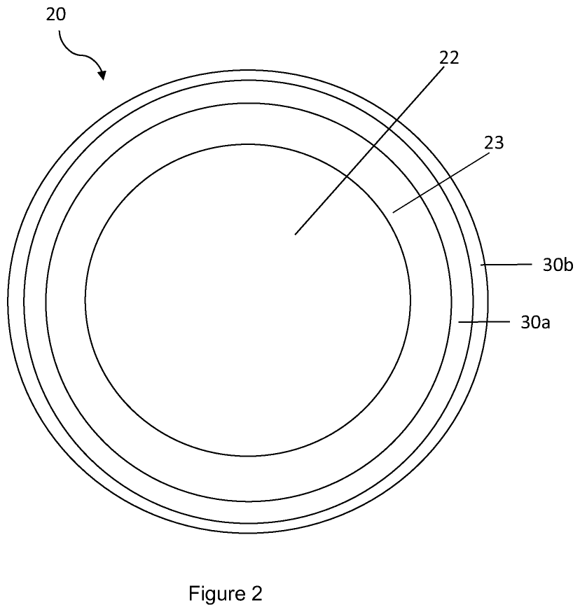

FIG. 2 is a cross-sectional diagram of an example of an ITM. The ITM includes a base 22 and an ITM blanket. The ITM blanket comprises a supportive portion comprising and a substrate layer 23, which is disposed on the base 22. The base 22 may be a metal cylinder. The substrate layer 23 may comprise or be a thermoplastic polyurethane layer. The ITM 20 also comprises a silicone release layer 30 (comprising a first silicone release layer 30a and a second silicone release layer 30b) disposed on the substrate layer 23.

The substrate layer 23 may comprise or further comprise (if it also comprises a thermoplastic polyurethane layer) a rubber layer which may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM). For example, the rubber layer may comprise an at least partly cured acrylic rubber, for example an acrylic rubber comprising a blend of acrylic resin Hi-Temp 4051 EP (Zeon Europe GmbH, Niederkasseler Lohweg 177, 40547 Düsseldorf, Germany) filled with carbon black pearls 130 (Cabot, Two Seaport Lane, Suite 1300, Boston, Mass. 02210, USA) and a curing system which may comprise, for example, NPC-50 accelerator (ammonium derivative from Zeon).

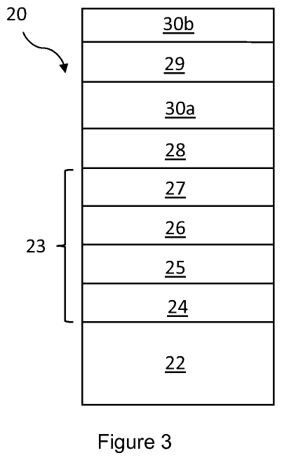

FIG. 3 shows a cross-sectional view of an example of an ITM having a substrate layer 23 comprising an adhesive layer 24 disposed between the base 22 and a compressible layer 25 for joining the compressible layer 25 of the substrate layer 23 to the base 22, a conductive layer 26 may be disposed on the compressible layer 25, and a compliance layer 27 (also called a soft compliant layer) may be disposed on the conductive layer 26. A primer layer 28 is disposed between the substrate layer 23 and the first silicone release layer 30a. At least one of the layers 24 to 27 may comprise a thermoplastic polyurethane. A primer layer 29 is disposed on the first silicone release layer 30a. A second silicone release layer 30b is disposed on the primer layer 29.

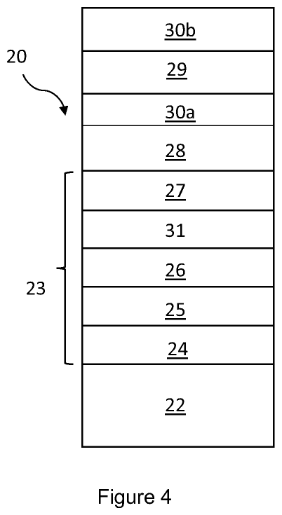

FIG. 4 shows a cross-sectional view of an ITM having a substrate layer 23 comprising an adhesive layer 24 disposed between the base 22 and a compressible layer 25 for joining the compressible layer 25 of the substrate layer 23 to the base 22, a conductive layer 26 is disposed on the compressible layer 25, a layer comprising a thermoplastic polyurethane 31 is disposed on the conductive layer 26, and a compliance layer 27 (also called a soft compliant layer) is disposed on the conductive layer 26. The first silicone release layer 30a is disposed on a primer layer 28, which is disposed on the compliance layer 27. A primer layer is disposed on the first silicone release layer 30a. A second silicone release layer 30b is disposed on the primer layer 29.

The adhesive layer may be a fabric layer, for example a woven or non-woven cotton, synthetic, combined natural and synthetic, or treated, for example, treated to have improved heat resistance, material. In an example the adhesive layer 23 is a fabric layer formed of NOMEX material having a thickness, for example, of about 200 μm.

The compressible layer 25 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). The compressible layer may comprise a thermoplastic polyurethane.

The compliance layer 27 may comprise a soft elastomeric material having a Shore A hardness value of less than about 65, or a Shore A hardness value of less than about 55 and greater than about 35, or a Shore A hardness value of between about 42 and about 45. In some examples, the compliance layer 27 comprises a polyurethane or acrylic. In some examples, the compliance layer 27 comprises a thermoplastic polyurethane. Shore A hardness is determined by ASTM standard D2240. In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM)

In an example, the compressible layer 25 and the compliance layer 27 are formed from the same material.

In some examples, the conductive layer 26 comprises a rubber, for example, an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer 26 comprises a thermoplastic polyurethane and one or more conductive materials. In some examples, the conductive layer 26 may be omitted, such as in some examples in which the compressible layer 25, the compliance layer 27, the first silicone release layer 30a or the second silicone release layer 30b are partially conducting. For example, the compressible layer 25 and/or the compliance layer 27 may be made to be partially conducting with the addition of conductive carbon black or metal fibres.

The primer layer 28 may be provided to facilitate bonding or joining of the first silicone release layer 30a to the substrate layer 23.

The primer layer 28 applied to the substrate layer 23 may comprise a first primer and/or a second primer as described herein. The primer layer 28 may be applied to the substrate layer 23 as two separate layers, one layer containing the first primer and the other layer containing the second primer.

The rubbers of the compressible layer 25, the conductive layer 26 and/or the compliance layer 27 of the substrate layer 23 may have been uncured when the primer layer 28 is applied thereon.

The primer layer 29 may be provided to facilitate bonding or joining of the second silicone release layer 30b to the first silicone release layer 30a.

The primer layer 29 applied to the first silicone release layer 30a may comprise a first primer and/or a second primer as described herein. The primer layer 29 may be applied to the first silicone release layer 30a as two separate layers, one layer containing the first primer and the other layer containing the second primer.

The first silicone release layer 30a of the ITM 20 may be a silicone release layer that is formed by curing a silicone release formulation as described herein.

The first silicone release layer 30a may have been formed on the ITM by applying a layer of a silicone release formulation to a supportive portion of the ITM. For example, the silicone release layer may be applied to the substrate layer 23 or on top of a curable primer layer which has already been applied to the substrate layer 23. The curable primer layer and the silicone release layer may have been cured at the same time.

In some examples, once cured, the ITM comprises a first silicone release layer 30 disposed on a substrate layer 23, or, if present, disposed on a primer layer 28.

In some examples, the second silicone release layer 30b of the ITM 20 may be a silicone release layer that is formed by curing a silicone release formulation as described herein.

The second silicone release layer 30b may have be formed on the ITM by applying a layer of the silicone release formulation to the primer layer 29 disposed on the first silicone release layer 30a. For example, the second silicone release layer 30b may be applied on top of a curable primer layer which has already been applied to the first silicone release layer 30b. The curable primer layer and the silicone release layer may have been cured at the same time.

In some examples, once cured, the ITM comprises a second silicone release layer 30b, a primer layer 29 disposed on a first silicone release layer 30a, which may be disposed on a substrate layer 23, or, if present, disposed on a primer layer 28.

In some examples, the silicone release formulation forms a silicone polymer matrix on curing, thus forming the cured silicone release layer.

### EXAMPLES

The following illustrates examples of the methods and other aspects described herein. Thus, these Examples should not be considered as limitations of the present disclosure, but are merely in place to teach how to make examples of the present disclosure.

Materials

Trisiloxane Surfactant

Silwet L-77 [polyethyleneglycol mono(3-tetramethyl-1-(trimethylsiloxy)disiloxanyl)propyl)ether; molecular weight: 600 g/mol; available from Momentive]

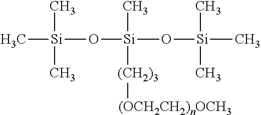

Organosilanes

Primer G: (3-Glycidoxypropyl)trimethoxysilane (available from ABCR):

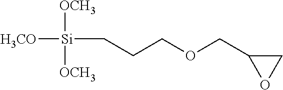 [SMILES: CO[Si](CCCOCC1CO1)(OC)OC]

MEMO: 3-Methacryloxypropyltrimethoxysilane (available from Evonik Industries):

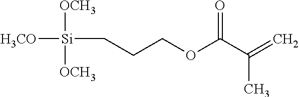 [SMILES: C=C(C)C(=O)OCCC[Si](OC)(OC)OC]

V3M (vinyltrimethoxysilane; available from ABCR):

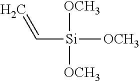

Photoinitiator

Duracur® 1173 (available form BASF™):

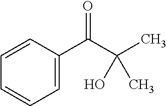

Catalyst

Tyzor AA-75 (75 wt. % in isopropanol; available from Dorf-Ketal)

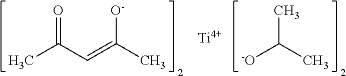

Karstedt's catalyst (platinum divinyl tetramethyl disiloxane complex): either a ˜10 wt. % in xylene; (purchased from Johnson Matthey and used as received) or a 0.5 wt. % platinum solution in isopropanol (available from ABCR):

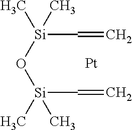

Polyalkylsiloxanes

Polymer VS500 (vinyl-terminated polydimethylsiloxane; available from ABCR):

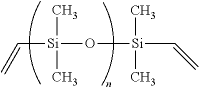

Polymer RV 5000 (pendent vinyl polydimethylsiloxane; available from ABCR):

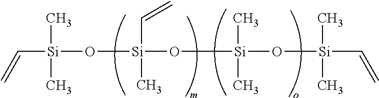

Cross-linker 210 (a polydimethylsiloxane cross-linker containing at least two Si—H bonds; available from ABCR):

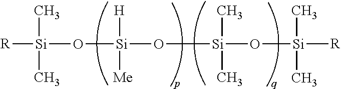

in which R=H or Me.

Other Components

Inhibitor 600 (an alkynol in Polymer VS; available from Evonik Industries).

Carbon Black: Ketjenblack™ EC600JD (available from AkzoNobel).

Cleaning Composition 1

A trisiloxane surfactant (Silwet L-77) was dissolved in isopropanol (IPA) at a concentration of 2 wt. % trisiloxane surfactant to form a cleaning composition. The cleaning composition was used to clean the used release layer (first silicone release layer) of an HP Indigo ITM blanket.

Cleaning Composition 2

Isopropanol was used as the cleaning composition.

Results

The mean contact angle (water and diiodomethane (CH₂I₂)) and surface free energy of the (first) silicone release layers was measured after cleaning with the cleaning composition. For comparison, the mean contact angle and surface free energy of the (first) silicone release layer of a used ITM blanket was also measured.

The mean contact angle was measured by using a mobile surface analyser (produced by Kruss company). The water and diiodomethane contact angles were measured at room temperature. At least 3 measurements were performed on every surface and mean values are reported.

The surface free energy was calculated by using the Owens-Wendt-Rabel-Kaelble algorithm, which is available in the Kruss company software supplied with the mobile surface analyser.

The cleaning composition removed adhered particles of ink and other impurities deposited during the printing process and increased the surface energy of the inert (first) silicone release layer. The increased surface energy of the inert (first) silicone release layer allows proper wetting with the first primer, enabling the first primer to be applied homogeneously and to adhere well to the (first) silicone release layer. A smooth and clean silicone release layer surface with a high surface energy was produced by this cleaning treatment.

Table 1 below reveals that lower water and diiodomethane contact angles and much higher surface free energy were obtained after cleaning the used silicone release layer with both the Example 1 (2 wt. % Silwet L-77 in IPA) and Example 2 (IPA) cleaning compositions, when compared to the untreated silicone release layer of the used ITM blanket. A high surface energy of the used silicone release layer is favourable for the adhesion of the first primer. However, it was noticed that cleaning without Silwet L-77 resulted in a less clean surface with some adhered particles of ink remaining on the surface. Hence, including Silwet L-77 in the cleaning composition significantly improves the cleaning process.

TABLE 1

| | | | Surface |
|---|---|---|---|
| | | | free |
| | Mean contact angle [°] | | energy |
| Substrate | Water | Diiodomethane | [mN/m] |
| No treatment | 104.5 (±1.1) | 76.0 (±1.8) | 20.5 (±1.2) |
| Cleaning composition 1 | 18.7 (±0.7) | 65.6 (±0.6) | 69.4 (±0.6) |
| (IPA + 2 wt. % | | | |
| Silwet L-77) | | | |
| Cleaning composition 2 | 30.0 (±0.5) | 63.3 (±0.5) | 64.3 (±0.7) |
| (IPA) | | | |

First Primer

A first primer composition was prepared by combining an epoxysilane, an organosilane (an organosilane comprising a methacrylate group), a photoinitiator and a trisiloxane surfactant in the proportions given in Table 2.

TABLE 2
First primer formulation

| | | Amount |
|---|---|---|
| | | [wt. %] |
| Epoxysilane | Primer G | 44 |
| Acryloxysilane | Dynasylan ® MEMO ™ | 50 |
| Photoinitiator | Darocur 1173 ™ | 5 |
| Trisiloxane surfactant | Silwet L-77 | 1 |

Second Primer

A second primer composition was prepared by mixing an epoxysilane, a vinyl silane, a first catalyst, a second catalyst and a trisiloxane surfactant in the proportions given in Table 3.

TABLE 3
Second primer formulation

| | | Amount |
|---|---|---|
| | | [wt. %] |
| Epoxysilane | Primer G | 51 |
| Vinyl silane | V3M | 35 |
| First catalyst | Tyzor AA75 | 10 |
| Second catalyst | Karstedt solution (9 wt. % Pt) | 3 |
| Trisiloxane surfactant | Silwet L-77 | 1 |

Silicone Release Formulation

A vinyl-terminated polydimethylsiloxane (polymer VS500; viscosity: 500 mPa·s, 800 g) was mixed with a pendent vinyl polydimethylsiloxane (polymer RV5000; viscosity: 3,000 mPa·s; 200 g) at a weight ratio of 4:1. To this was added conductive particles (carbon black; 1 wt. %) and the mixture was homogenized at a shear rate of 6,000 rpm over 6 minutes by using a high-shear mixer. After homogenization, a polydimethylsiloxane cross-linker containing at least two Si—H bonds (Cross-linker 210; 100 g) was added. Inhibitor 600 (50 g) was then added, followed by a thermally activated platinum catalyst (Karstedt's catalyst at 0.5 wt. % in IPA). Finally, the mixture was homogenized at 6,000 rpm for 2 minutes.

TABLE 4
silicone release formulation

| | | | | Functional |
|---|---|---|---|---|
| | | | Dynamic | group |
| | | Mass | viscosity | content |
| Materials | | [g] | [mPa · s] | [mmol/g] |
| Vinyl-terminated | VS500 | 800 | 500 | 0.14 vinyl |
| polydimethylsiloxane | | | | |
| Pendent vinyl | RV 5000 | 200 | 3000 | 0.4 vinyl |
| polydimethylsiloxane | | | | |
| Polydimethylsiloxane | Cross-linker 210 | 100 | 900 | 4.2 SiH |
| cross-linker | | | | |
| Inhibitor | Inhibitor 600 | 50 | 900 | 0.11 vinyl |
| Catalyst | Karstedt solution | 5 | 500 | 0.14 vinyl |
| | (0.5 wt. % Pt) | | | |
| Conductive carbon | Ketjenblack ™ | 10 | | |
| black | EC600JD | | | |

ITM Blanket Refurbishment Method

### Example 1—Blanket A

An ITM blanket that had been used in an LEP printer was selected. The used ITM blanket had the following structure (from bottom to top where the bottom is a layer which is in contact with the metal ITM drum (in use) and the top layer is a first silicone release layer:
1. Fabric based adhesive layer (e.g., woven or non-woven cotton, synthetic, combined, treated (according to heat resistance needed in some cases), etc.).
2. Rubber-based compressible layer with a large range of compressibility (e.g., NBR, HNBR, ACM, EPDM, PU, FLS, etc.).
3. Rubber-based conductive layer (e.g., NBR, HNBR, ACM, EPDM, etc.).
4. Rubber-based soft compliant layer (e.g., NBR, HNBR, ACM, EPDM, PU, FMQ, FPM, FKM, FFKM, etc.)
5. Primer layer, which may comprise one or more primer layers coated on the rubber-based soft compliant layer (layer no. 4) in a layer-by-layer process [e.g., a first primer layer (a cured composition formed from a pre-curing mixture of Primer G, Dynasylan MEMO and Darocur 1173) with a second primer layer thereon (a cured composition formed from pre-curing a mixture of Primer G, V3M, Tyzor AA-75 and Karstedt's catalyst)],
6. First silicone release layer (e.g., a cured composition formed from curing a mixture as described in Table 4). The first release layer has been repeatedly subjected to the LEP printing process in an LEP printer such that the performance of the first release layer has deteriorated.

The first silicone release layer of the ITM blanket was cleaned with cleaning composition 1. The first primer was applied to the cleaned silicone release layer by using a gravure coater with a gravure volume of 3 cm³/m² at a coating speed of 5 m/min. The first primer was cured under UV irradiation by using a 300 W/in Fusion H ultraviolet lamp at a line speed of 5 m/min to form a first primer layer disposed on the first silicone release layer. The second primer was applied to the first primer layer by using a gravure coater with a gravure volume of 5 cm³/m² at a coating speed of 5 m/min to form a layer of the second primer disposed on the first primer layer. Immediately thereafter, the silicone release formulation was applied to the layer of the second primer by using a gravure coater with a gravure volume of 4.2 cm³/m² at a coating speed of 5 m/min. The second primer layer and the silicone release formulation were then thermally cured by heating in an oven at 110° C. for 20 min to form a second silicone release layer disposed on the second primer layer.

To achieve good printing performance of the refurbished ITM blanket on the LEP printing press, it is preferred that the second release layer have a thickness in the range of 2 μm to 4 μm. Generally, the first release layer has a thickness of approximately 6 μm. The first and second primer layers are of submicron thickness and are not detectable using an optical microscope.

### Example 2—Blanket B (Comparative)

A refurbished ITM blanket was formed by following the method described in Example 1 except that the first silicone release layer was not cleaned before application of the first primer.

### Example 3—Blanket C

A refurbished ITM blanket was formed by following the method described in Example 1 except that no first primer was applied to the cleaned silicone release layer before application of the second primer.

### Example 4

A refurbished ITM blanket was formed by following the method in Example 1 except that cleaning composition 2 was used instead of cleaning composition 1.

### Example 5

A refurbished ITM blanket was formed by following the method in Example 1 except that neither the first primer nor the second primer contained the trisiloxane surfactant (Silwet L-77).

Results

Optical microscopy of the refurbished ITM blanket produced in Example 1 showed the second siloxane release layer adhered to the first siloxane release layer of the used ITM blanket.

Wet Abrasion Tests

The refurbished ITM blanket was soaked in a high purity isoparaffinic solvent (Isopar L) for 1 min at room temperature (20-25° C.) and then abraded with a cloth (a non-woven polyester/cellulose cloth produced by Essentra Porous Technologies, Chicopce, Mass., USA). The results of the wet abrasion test are given in Table 5. The results are scaled as follows:

1=bad, release layer easily removed;

2=fair, release layer removed with a small amount of effort;

3=good, release layer removed only with considerable effort;

4=excellent, release layer cannot be removed.

TABLE 5
wet abrasion test results

| | | First primer | Second | Wet |
|---|---|---|---|---|
| | Cleaning | applied and | primer | abrasion |
| | procedure | cured | applied | test result |
| Example 1 | Yes | Yes | Yes | 4 |
| (Cleaning composition 1) | | | | |
| Example 2 | None | Yes | Yes | 1 |
| Example 3 | Yes | No | Yes | 2 |
| (Cleaning composition 1) | | | | |

The results in Table 5 show that excellent adhesion of the second silicone release layer to the first silicone release layer is achieved by following the procedure described in Example 1. Additionally, the ITM blanket produced in Example 1 has been used in a liquid electrophotographic printer to produce good quality printed images.

Applying only the second primer without first forming the first primer layer detrimentally affects adhesion of the second silicone release layer to the first silicone release layer (Example 3). Without wishing to be bound by theory, it is considered that this reduction of adhesion is caused by the poisoning of the addition catalyst in the second primer and the silicone release formulation (by the cured polydimethylsiloxane in the first silicone release layer), reducing the extent of polymerisation that has been achieved when thermally curing the second silicone release layer.

Without wishing to be bound by theory, it is believed that the second silicone release layer does not adhere well to the first silicone release layer in Example 2 because of the low surface free energy of the uncleaned first silicone release layer of the (used) ITM blanket surface (see Table 1). The surface free energy is a key factor in determining the rate of wetting of the surface. The first primer is applied to the first silicone release layer (surface of the used ITM blanket) as droplets from the gravure roll. These must spread to a form a contiguous film in the (approximately) 10 seconds between the application of the second primer and the application of the (second) silicone release formulation, and thereby also facilitate spreading of the (second) silicone release formulation droplets to connect the droplets together and form a solid film.

The wet abrasion resistance of the refurbished ITM blanket of Example 4 was also tested. The second release layer in this refurbished ITM blanket was found to be less well adhered to the first release layer than for the Example 1 refurbished ITM blanket but better adhered than for the Example 2 refurbished ITM blanket. Without wishing to be bound by theory, it is believed that the higher mean contact angle for water, as well as the lower surface free energy, after cleaning with cleaning composition 2 rather than cleaning composition 1 causes this reduction in adhesion.

The wet abrasion resistance of the refurbished ITM blanket of Example 5 was also tested. The second silicone release layer in this refurbished ITM blanket was found to be less well adhered to the first silicone release layer than for the Example 1 refurbished ITM blanket but better adhered than for the Example 2 and 3 refurbished ITM blankets.

While the method and apparatus have been described with reference to certain examples, those skilled in the art will appreciate that various modifications, changes, omissions, and substitutions can be made without departing from the spirit of the disclosure. It is intended, therefore, that the method and apparatus be limited by the scope of the following claims. Unless otherwise stated, the features of any dependent claim can be combined with the features of any of the other dependent claims and any of the independent claims.

1. A method of refurbishing an intermediate transfer member (ITM) blanket comprising:
cleaning a silicone release layer of the ITM blanket with a cleaning composition;
applying a primer composition onto the silicone release layer of the ITM blanket to form a primer layer;
applying a silicone release formulation to the primer layer;
curing the silicone release formulation to form a silicone release layer;
wherein at least one of the cleaning composition and the primer composition comprises a polysiloxane surfactant.

2. The method according to claim 1, wherein both the cleaning composition and the primer composition comprises a polysiloxane surfactant.

3. The method according to claim 1, wherein the polysiloxane surfactant is a trisiloxane surfactant.

4. The method according to claim 3, wherein the trisiloxane surfactant is a trisiloxane surfactant according to formula 1 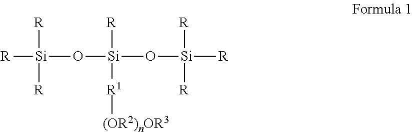
wherein
R, R¹ and R² are each independently selected from C1 to C6 alkyl groups;
R³ is selected from hydrogen and C1 to C6 alkyl groups; and
n is an integer of at least 1.

5. The method according to claim 4, wherein R¹ is selected from C1 to C4 alkyl groups.

6. The method according to claim 4, wherein n is an integer of from 1 to 12.

7. The method according to claim 4, wherein R² is selected from ethyl and isopropyl groups.

8. The method according to claim 1, wherein the polysiloxane surfactant is

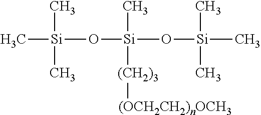

9. The method according to claim 1, wherein the silicone release formulation applied to the primer layer comprises:
a polyalkylsiloxane containing at least two vinyl groups;
a polyalkylsiloxane cross-linker containing at least two Si—H bonds; and
a catalyst or photoinitiator.

10. The method according to claim 1, wherein the primer composition comprises:
a polysiloxane surfactant;
an organosilane; and
at least one of a catalyst or a photoinitiator.

11. The method according to claim 1, wherein applying the primer composition onto the silicone release layer of the ITM blanket to form a primer layer comprises:
applying a first primer composition onto the silicone release layer to form a first primer layer; and
applying a second primer composition to the first primer layer to form a second primer layer;
wherein the first primer composition comprises:
a polysiloxane surfactant;
an organosilane; and
a photoinitiator; and;
wherein the second primer composition comprises:
a polysiloxane surfactant;
an organosilane; and
at least one catalyst.

12. The method according to claim 1, wherein the silicone release formulation is cured by thermal curing or by UV curing.

13. An ITM blanket comprising:
a first silicone release layer;
a primer layer disposed on the first silicone release layer; and
a second silicone release layer disposed on the primer layer.

14. The ITM blanket according to claim 13, wherein the primer layer comprises a polysiloxane surfactant.

15. A primer composition comprising
a polysiloxane surfactant;
an organosilane; and
at least one of a catalyst or a photoinitiator.
